(19) United States
(12) Patent Application Publication
(10) Pub. No.: US 2025/0373197 A1
(43) Pub. Date: Dec. 4, 2025

(54) Portable Solar Power Generation System

(71) Applicant: John Sheesley, Rockport, TX (US)

(72) Inventor: John Sheesley, Rockport, TX (US)

(21) Appl. No.: 19/225,552

(22) Filed: Jun. 2, 2025

Related U.S. Application Data
(60) Provisional application No. 63/654,703, filed on May 31, 2024.

(51) Int. Cl. H02S 20/32; H02S 30/10; H02S 40/32; H02S 40/34; H02S 40/36; H02S 40/38

(52) U.S. Cl. CPC H02S 20/32; H02S 30/10; H02S 40/32; H02S 40/34; H02S 40/36; H02S 40/38

(57) ABSTRACT

A portable solar power generation system comprising solar panels and batteries is fitted with a combiner box, charge controller, and an inverter and uses intermodal frame racks configured to be compatible with ISO shipping container conventions to provide a base load, average daily demand, or peak load when combined with an integrated power storage system for residential, commercial and power utility use to allow for flexibility in transportation from one location to another. In use, the power generation system continuously adjusts in real time to capture the sun's radiance throughout the day. Stacking of multiple power generation systems facilitates transporting several systems simultaneously. Receptacle outlets within the power generation system allow for instant power upon delivery. The present invention offers a “move in” or “move out” power generation system within days and is simply scalable from one to thousands.

### STATEMENT REGARDING FEDERALLY-SPONSORED RESEARCH OR DEVELOPMENT

This original non-provisional patent application claims priority to and the benefit of U.S. Provisional Patent Application No. 63/654,703, filed May 31, 2024, entitled “Portable Solar Power Generation System,” which is incorporated by reference herein.

### CROSS-REFERENCES TO RELATED APPLICATIONS

None.

### BACKGROUND

### 1. Field of the Invention

The present invention relates to power generating systems. More specifically, the invention relates to a portable solar power generation system that uses intermodal frame racks configured to be compatible with International Organization for Standardization (ISO) shipping container conventions to provide a base load, average daily demand, or peak load when combined with an integrated battery system.

### 2. Description of the Related Art

Solar power generating systems have been around for decades for both residential and commercial use. Today, a solar power generation system is a combination of multiple solar panels, each with a power productive capacity of 225 to 700 watts, mounted upon fixed structures of pipes, tubes, clamps and roofs producing power from the sun.

These fixed structures can be residential rooftops, commercial buildings, carports and or dedicated solar farms with panels mounted to a series of horizontal torque tubes attached to vertical pipes or beams placed in the ground as posts covering several hundred to thousands of acres of land. These systems all require an advanced design, permitting, acquisition of property all requiring weeks to years for approval along with a land lease commitment of twenty to thirty years.

The installation of the above systems requires weeks to years to install depending on the size of the system and its location. Most farm locations are located away from available employment sources and require transporting workers to and from the construction site for many months, usually under less than favorable working conditions but favorable pay scales.

A tracker operating system is generally incorporated in solar farms and is a mechanical drive system that adjusts the panels constantly to track the sun's path during the day thereby increasing the energy production by as much as twenty percent.

The energy produced is transmitted via cables, under or above ground from the individual panels to combiner boxes, which as the name implies, combines all the wires into a single cable which then transport the energy to an inverter.

The inverter converts the solar produced direct current (DC) energy into alternating current (AC) to be sent into the national power grid via a transformer or directly to a home, business, or commercial application.

The transformer steps up the voltage from the inverter matching the grid for delivery and sale.

A solar array only produces energy during daylight hours so its ability to be considered a constant source of energy is unavailable.

With the increasing need to provide 24-hour reliability from alternative energy, storage was the solution. The battery energy storage system (BESS) was created to complement solar energy production, store it, and deliver it when the sun is not shining. With the combination of solar and storage, reliable 24-hour power is very marketable with an infinite number of end users. The limiting factors to date have been the ability to deploy this energy to scale, where it is most needed, without months and years of preparation.

There is a need for a solar power generation system that can be deployed as a single stand-alone solar generator or combined to create as large a solar farm array providing a base load, average daily demand, or peak load when combined with the integrated battery system. There is a further need for a solar power generation system to be portable, deployable, and operational within hours or days versus months or years.

There is still further need for a solar power generating system that can be deployed as an Add-On to an existing ISO shipping container or mounted on a specifically designed skid, commercially available under the trademark BUNKS®, with all the electrical components mounted within the rail as an independent solar energy generator with battery storage operating just as any portable gasoline generator but without the need for gasoline and the associated noise.

There is also a substantial need for a solar power generation system that is an all-in-one system that is easily deployed and contains all the requirements for a complete operational system upon delivery.

### BRIEF SUMMARY OF THE INVENTION

The present invention provides a solar power generation system comprised of a power generating component and uses an open frame rack or skid configured to be compatible with ISO shipping container conventions as a platform which facilitates portability.

Solar panels are bolted to channel iron supports which are welded to a single length of pipe containing two split ring male ISO twist-lock connectors. Collectively, this support structure is called a Rail. The Rail can be mounted on any conventional shipping container by means of the male ISO twist-lock.

The skid, a version of which is available under the trademark BUNKS®, functions as a platform for a wide variety of materials. ISO compatible corner pin blocks and standard forklift pockets allow for flexibility in handling and transporting loads from one location to another. Details regarding the open framed rack have been discussed and are included in U.S. Pat. No. 11,816,629, which is incorporated by reference herein. An area of the present invention (e.g., clearance between solar panels on the array of solar panels) remains free for a company, for example, to include a company logo or signage thereon.

The portable solar power generation system may be quickly installed to either skids (and variation of same) or to ISO shipping containers, or both, along with transportable ease using the twist-locks for stacking multiple units simultaneously. The present invention may be assembled at a relaxed pace in under one (1) hour with no more than three (3) installers.

An additional advantage, thus, is the resulting substantial savings in time and costs.

For purposes of this application, the terms “skid,” “base,” “platform,” “open frame rack,” and “bunk” are synonymous.

### BRIEF DESCRIPTION OF THE FIGURES

FIG. 1 depicts an environmental perspective of an embodiment of the present invention.

FIG. 2 is a left side perspective of an embodiment of the present invention showing components under the array of solar panels.

FIG. 3 is the top perspective view of an embodiment of the present invention showing individual solar panels that comprise the array of solar panels.

FIG. 4 is a top view of the framework of the solar panel layout of the present invention.

FIG. 5 is a top view of an individual support bracket of the framework of the solar panel layout of the present invention with respect to FIG. 4.

FIG. 6 is a perspective side view of an individual support bracket of the framework of the solar panel layout with respect to FIG. 4 showing the connection between two components, the individual support bracket and rail tubing.

FIG. 7 is a cross sectional view of FIG. 6 along lines 7-7 showing the cross section of an individual support bracket of the framework of the solar panel layout with respect to FIG. 4.

FIG. 8 is a perspective view of an embodiment of the present invention showing the connection between components.

FIG. 9 is an enlarged section of FIG. 8 showing the connecting mechanism that secures the rail tubing with array of solar panels to the skid.

FIG. 10 is a perspective view of a battery cradle or holder and an energy storage device of an embodiment of the present invention.

FIG. 11 depicts a top perspective view of a battery cradle with accompanying energy storage device of an embodiment of the present invention.

FIG. 12 depicts a bottom perspective view of a battery cradle with accompanying energy storage device with respect to FIG. 11 of an embodiment of the present invention.

FIG. 13 is a perspective view of two battery cradles with accompanying energy storage devices in a parallel circuit configuration of an embodiment of the present invention showing.

FIG. 14 depicts a perspective view showing two battery cradles with accompanying energy storage devices in the process of switching from a parallel circuit configuration to a series circuit configuration of an embodiment of the present invention.

FIG. 15 is a perspective view of an embodiment showing two battery cradles with accompanying energy storage devices in a series circuit configuration of an embodiment of the present invention.

FIG. 16 is a perspective view of an embodiment depicting how the battery cradle with accompanying energy storage device enters within the rail tubing in a parallel circuit configuration of an embodiment of the present invention.

FIG. 17 is a perspective view of an embodiment depicting how the battery cradle with accompanying energy storage device enters within the rail tubing in a series circuit configuration of an embodiment of the present invention.

FIG. 18 depicts several battery cradles with accompanying energy storage devices enter within the rail tubing of an embodiment of the present invention.

FIG. 19 is a perspective top and bottom view of a multiple energy storage device holding battery cradle of an embodiment of the present invention.

FIG. 20 depicts a perspective view of a twist lock locking pin used to engage and secure the rail tubing with array of solar panels to a skid or cargo container in an embodiment of the present invention.

FIG. 21 is a right-side perspective view of the twist lock locking pin with respect to FIG. 20 used to engage and secure the rail tubing with array of solar panels to a skid or cargo container in an embodiment of the present invention.

FIG. 22 is a front plan view of the twist lock locking pin with respect to FIG. 20 used to engage and secure the rail tubing with array of solar panels to a skid or cargo container in an embodiment of the present invention.

FIG. 23 is a back plan view of the twist lock locking pin with respect to FIG. 20 used to engage and secure the rail tubing with array of solar panels to a skid or cargo container in an embodiment of the present invention.

FIG. 24 is a top view of the twist lock locking pin with respect to FIG. 20 used to engage and secure the rail tubing with array of solar panels to a skid or cargo container in an embodiment of the present invention.

FIG. 25 is an environmental perspective view of two twist lock locking pins used to engage and secure the rail tubing with array of solar panels to a skid or cargo container in an embodiment of the present invention.

FIG. 26 is a partial perspective view of the back or bottom side (depending upon orientation) of various electronic components in an embodiment of the present invention.

FIG. 27 is a partial perspective view of various electronic components in an embodiment of the present invention.

FIG. 28 depicts an alternative embodiment of the present invention showing a ball and harness used in lifting the present invention.

FIG. 29 shows a perspective view of an alternative embodiment in mid-assembly of the solar panel layout and rail tubing attached to a skid having four pin posts.

FIG. 30 shows a close-up perspective view of an alternative embodiment in mid-assembly of the solar panel layout and rail tubing attached to a skid having four pin posts.

FIG. 31 shows a back perspective view of an alternative embodiment in mid-assembly of a first array of solar panels and rail tubing attached to a skid having four pin posts.

FIG. 32 shows a front perspective view of an alternative embodiment of the present invention in mid-assembly of a first array of solar panels and rail tubing attached to a skid having four pin posts.

FIG. 33 shows a view of the dual array of solar panels mounted on a skid having four pin posts an alternative embodiment of the present invention.

FIG. 34 depicts an alternative embodiment in mid-assembly of the solar panel layout and rail tubing, both of reduced lengths attached to the top of an ISO compatible container of reduced size.

FIG. 35 depicts an alternative embodiment of a single array of solar panels having a reduced number of solar panels attached to the top of an ISO compatible container of reduced size.

FIG. 36 shows a perspective view of an alternative embodiment of the present invention without the array of solar panels to show the external batteries.

### DETAILED DESCRIPTION OF THE INVENTION

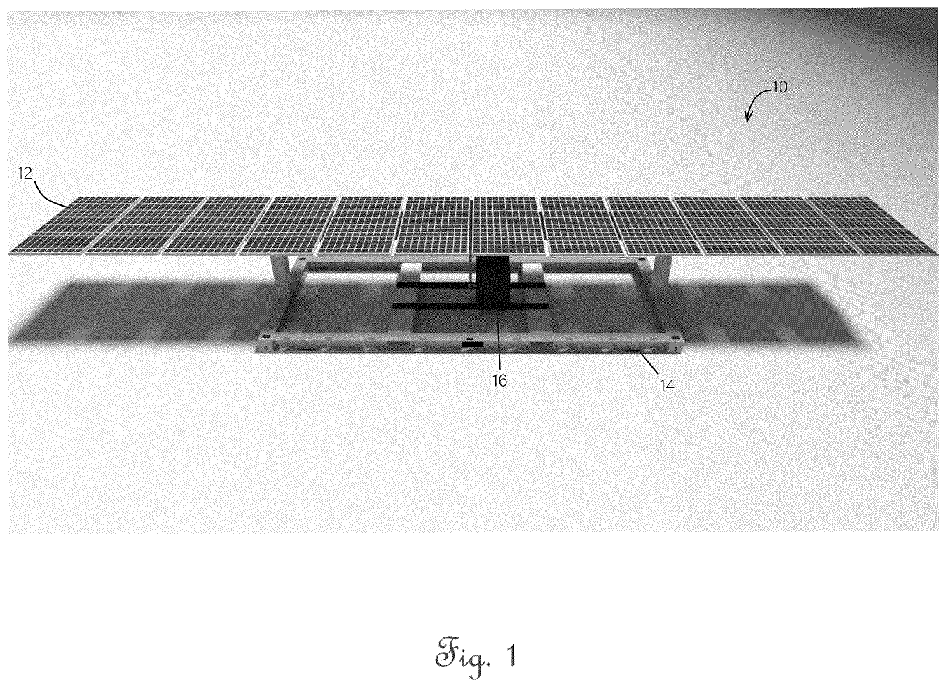

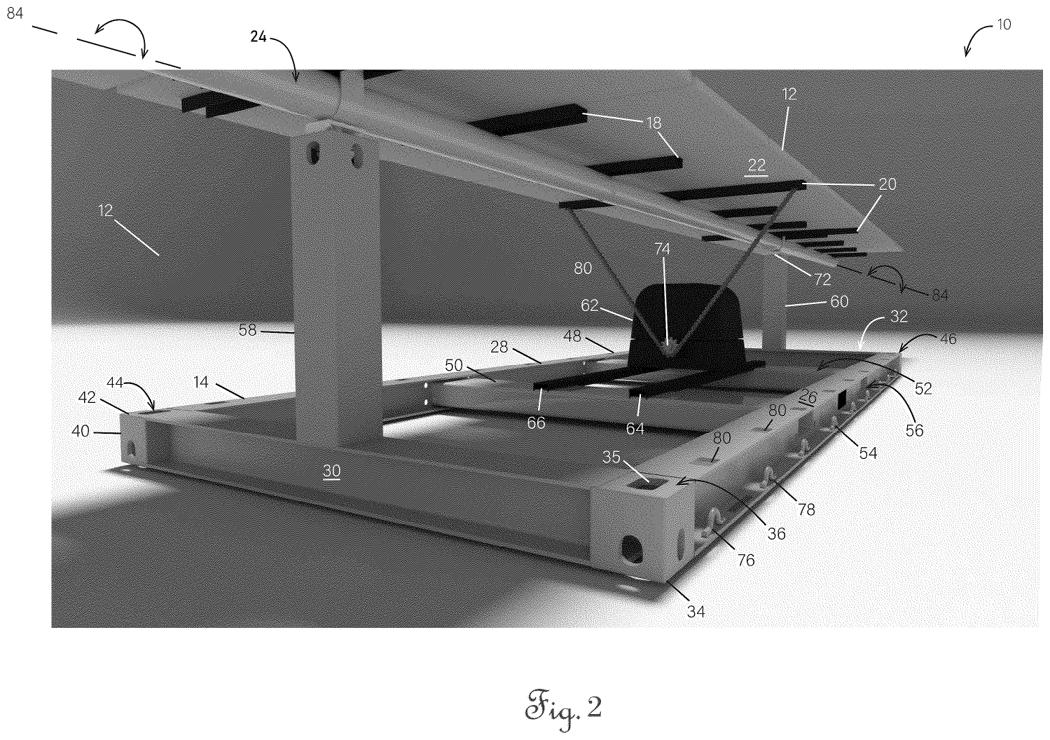

Turning now to FIG. 1, solar power generation system 10 is comprised of array of solar panels 12 connected to platform 14. Tracker system 16 is attached to platform 14 via support brackets. A more detailed description of solar power generation system 10 can be seen in FIG. 2.

Turning now to FIG. 2, support brackets 18 and support brackets 20 are attached to bottom surface 22 of array of solar panels 12. Each solar panel in array of solar panels 12 is 80 inches in length and 40 inches in width. Support brackets 20 are longer in length than support brackets 18. However, the lengths of both support brackets 18 and 20 are less than the width of array of solar panels 12. Rail tubing 24 is attached and anchored to support brackets 20 at two connecting points.

Skid 14 has a rectangularly configured frame comprised of side rails 6 and 28, and end rails 30 and 32. Pin posts 58 and 60 extended distally from the middle of end rails 30 and 32, respectively. Side rails 26 and 28 have I-beam configurations. Side rails 26 and 28 may also have different configurations, such as a tubular configuration, and still remain within the contemplation of the present invention. Tie-down anchors are on the bottom of each I-beam side rail. For example, tie-down anchors 76 and 78 are spaced at predetermined intervals along lower surface of side rail 26. The tie down anchors are vertically aligned with the plurality of strap ports 80 and 82 along upper surface of I-beam side rail 26. If necessary, a strap, such as a tie down strap or other securing device, such as ratchet straps, passes through strap ports 80 to secure the tie down anchors (e.g., tie down anchors 76 and 78). In this fashion, the tie down strap (not shown) is protected from damage during transport. Side rail 28 has a similar configuration. Side rails 26 and 28 are 8 inches in height. However, different heights and sizes may also be used and still remain within the contemplation of the present invention.

Still referring to FIG. 2, each corner of platform 14 is comprised of an ISO compatible receiver block. For example, ISO compatible block 34 is at the corner where end rail 30 and side rail 26 meet. Pin pad 36 is comprised of a steel plate that has aperture 38 (for receiving male twist lock locking pin) that traverses the center of pin pad 36, as shown in FIG. 2. Alternatively, pin post 58 (and frame) may also have a different configuration, such as a cylindrical configuration (e.g., FIG. 36). Pin pad 36 is recessed and welded into the top of ISO compatible block 34. ISO compatible block 40 having pin pad 42 and aperture 44 is similarly configured, as are ISO compatible blocks 46 and 48. The ISO compatible receiver block is female and configured to receive the male twist lock locking pin. The inventor uses the term “pin” as a reference to where the connecting male twist lock locking “pin” attaches to the female ISO compatible receiver block, as will be discussed later on.

There are two pin posts 58 and 60. Each pin post extends distally from an end rail. For example, pin post 58 extends distally from the middle of end rail 30. Pin post 60 extends distally from the middle of end rail 32. Pin post 58 is comprised of hollow steel tubing in a rectangular configuration. Pin post 58 connects to end rail 30. The connection is permanent and may be accomplished through welding. Similar to ISO compatible block 34, each pin post has a pin pad comprised of a steel plate that has an aperture that traverses the center of the pin pad. For example, apertures (not shown) on top end 68 of pin post 58 provide engagement locations for locking pins. Pin post 60 is similarly configured, having a pin pad welded at the top therein and having an aperture traversing the pin pad to provide engagement locations for locking pins.

The height of the pin posts in the present invention is 48 inches. However, different heights, such as 24 inches and 60 inches, may also be used and still remain within the contemplation of the present invention.

Forklift tube 50 and forklift tube 52 connect side rail 26 to side rail 28, providing additional strength and reinforcement to platform 14. In addition, forklift tubes 50 and 52 are hollow and form forklift pockets 54 and 56, respectively, on side rail 26 and side rail 28 (not shown). Forklift pockets 54 and 56 allow for a forklift to engage base or skid 14 for transporting to a different location.

Still referring to FIG. 2, braces 64 and 66 are attached and anchored to forklift tube 50 and 52, respectively. The tracker system of the present invention comprises a tracker motor, and a cable or chain passing through a gear point connected to the tracker motor. Tracker motor 62 is mounted on braces 64 and 66. Array of solar panels 12 may be continuously rotated in real time about longitudinal axis 84 by means of cable or chain 86 which attaches to braces 20 on bottom surface 22 of array of solar panels 12, the movement of which is caused by chain 86 passing through gear 74 of tracker motor 62, such that array of solar panels 12 continuously captures in real time the maximum amount of sunlight from the sun as the sun traverses the sky throughout a given day. More specifically, the ends of chain 86 are attached to either ends of supports or braces 20 under array of solar panels 12. When tracker motor 62 rotates gear 74 in a first direction, gear 74 latches to chain 86, pulling chain 86 in the first direction, causing array of solar panels 12 to rotate in the first direction about longitudinal axis 84. When tracker motor 62 rotates gear 74 in a second direction, gear 74 latches to chain 86, pulling chain 86 in the second direction, causing array of solar panels 12 to rotate in the second direction about longitudinal axis 84. The chain used in the present invention is similar to that of a bicycle chain or a gate opener chain. However, a cable may also be used in place of a chain and still remain within the contemplation of the present invention. For example, a 48-volt capstan winch may be used with a 5/16 flexible cable, wrapped three times and connected to the supports or braces with two turn buckles that may be tightened and adjusted, as desired. Tracker system 16 may be remotely operated (e.g., via Bluetooth technology or other comparable service) such as with a cellular phone or other portable device, or can be preprogrammed.

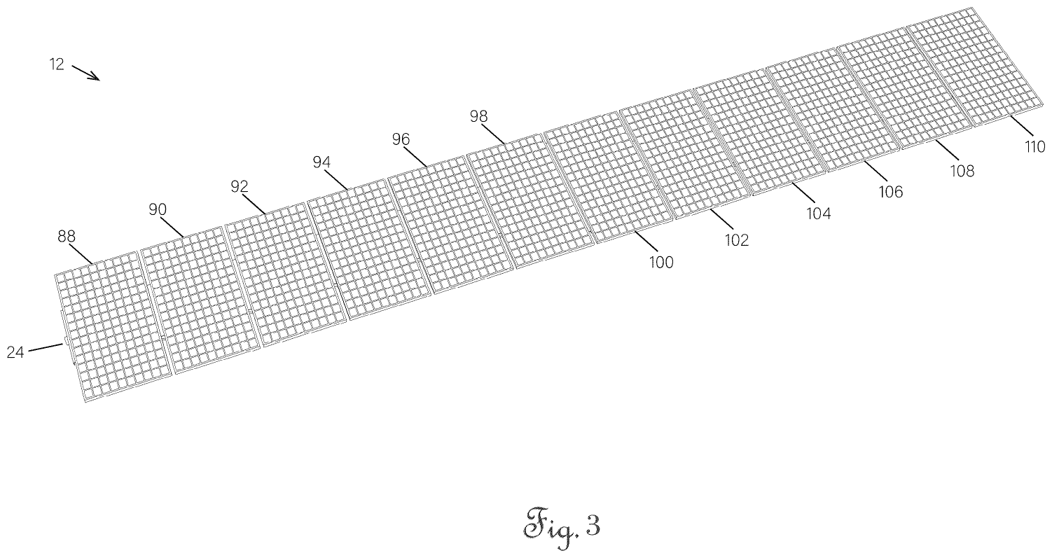

Referring now to FIG. 3, array of solar panels 12 is comprised of several individual solar panels. Solar panels 88, 90, 92, 94, 96, 98, 100, 102, 104, 106, 108, and 110 together comprise array of solar panels 12. Array of solar panels 12 is connected to rail tubing 24, as previously discussed. Though the present invention utilizes 12 solar panels in the array, more or less solar panels may also be used within the array and still remain within the contemplation of the present invention.

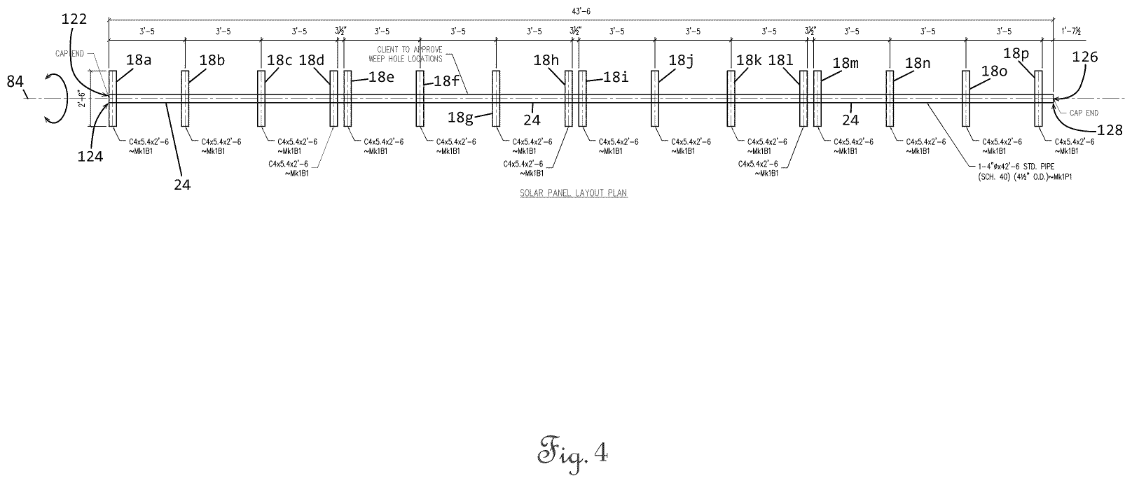

Turning now to FIG. 4, a layout of the present invention illustrates several support brackets (which are attached to the bottom surface of the array of solar panels, though not shown in this figure) attached to the rail tubing. For example, support brackets 18a-18p are attached at predetermined intervals along rail tubing 24. End cap 122 fits within end 124 of rail tubing 24. Similarly, on the opposite side of rail tubing 24, end cap 126 fits within end 128 of rail tubing 24, as shown in FIG. 4.

Support brackets 18a-18p are 2 feet, 6 inches in length. The length of rail tubing 24 is dependent on the widths of the solar panels in array of solar panels 12. However, generally, rail tubing 24 has a length in the range of 40 to 42 feet and weighs between 800-1200 lbs. The predetermined interval between the support brackets is 40 inches. However, the lengths of support brackets, support bracket intervals, and rail tubing may vary and still remain within the contemplation of the present invention.

When the solar panels are installed together, there is minimum clearance between the panels. A clearance of 3-5″ is a lifting center point for a crane to lift the present invention, i.e., the SolarRail™, for, for example, moving the solar power generation system from one location to another, or to facilitate attachment to an ISO compatible container by lifting the solar power generation system above the ISO compatible container and resting the solar power generation system on top of the ISO compatible container once secured thereto.

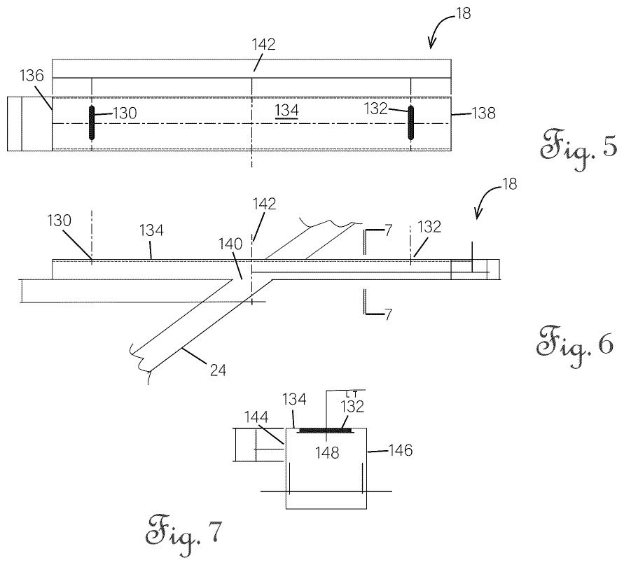

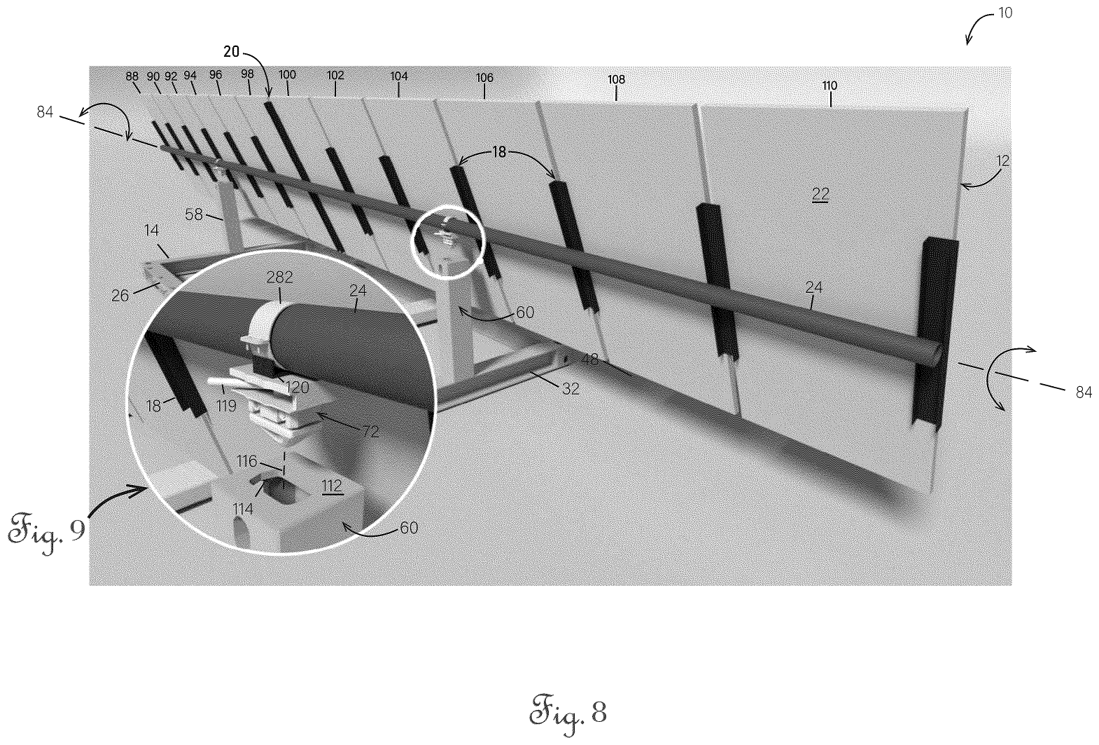

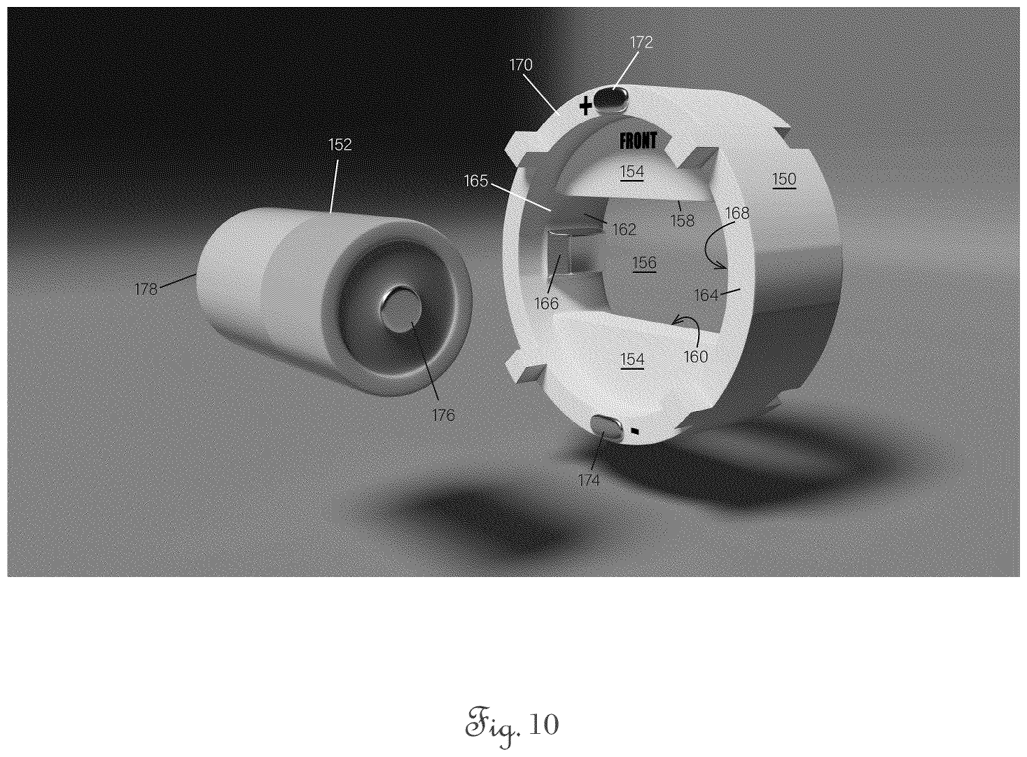

A detailed discussion of a single bracket, e.g., support bracket 18, is provided in connection with FIGS. 5-7. Top surface 134 has two slots towards each end of top surface 134. For example, slot 130 is proximal to end 136 of support bracket 18. Slot 132 is proximal to end 138 of support bracket 18, as shown in FIG. 5. The slots are used in conjunction with fastening (e.g., bolting) of the solar panels. Slots 130 and 132 are a distance of 2 feet 2 inches apart from each other. Support brackets are 5″ wide (channel) and 30″ long each and have two slots each. Each slot is ⅜″ wide×3½″ long and 14″ from center 142 of support bracket 18 in each direction. Support bracket 18 has inwardly curved portion 140 to accommodate the curvature of railing tubing 24, as shown in FIG. 6. FIG. 7 is a cross sectional view of support bracket 18 taken over section 7-7 in FIG. 6. Support bracket 18 is 1¾ inches in height and 5 inches wide across. Sides 144 and 146 together with top surface 134 of support bracket 18 define channel 148 of support bracket 18.

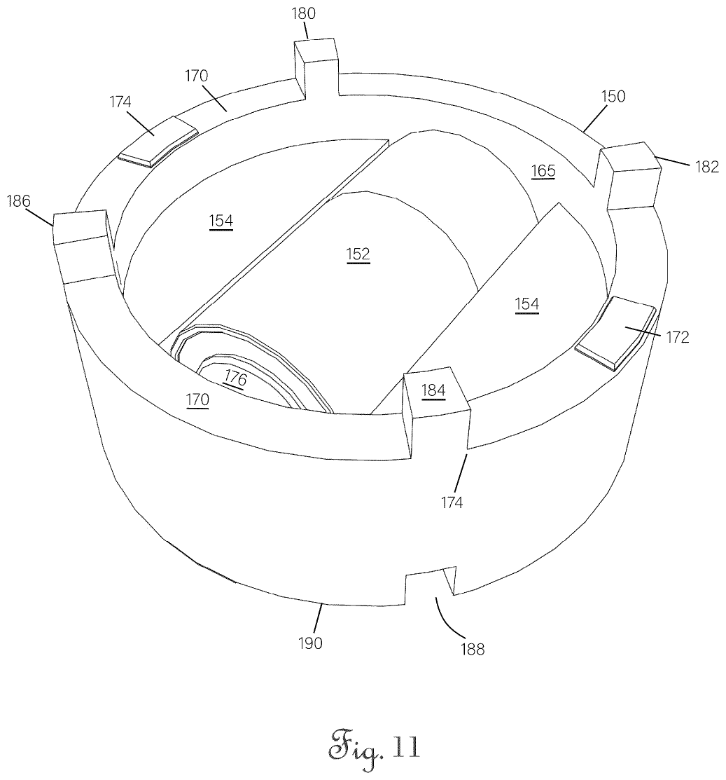

Referring now to FIGS. 8 and 9, array of solar panels 12 of solar power generation system 10 is attached to rail tubing 24 via support brackets 18 and 20. Array of solar panels 12 is comprised of solar panels 88, 90, 92, 94, 96, 98, 100, 102, 104, 106, 108, and 110. Array of solar panels 12 attached to rail tubing 24 and is releasably attached to skid 14 such that array of solar panels 12 may rotate about longitudinal axis 84 when in use, as shown in FIG. 8.

FIG. 9 is a close up insert of one of the connecting points (on rail tubing 24) between array of solar panels 12 and rail tubing 24, on the one hand, and skid 14 on the other. The connecting points coincide with pin post 58 and pin post 60 of skid 14. A closer view of a connecting point, and referring now to FIG. 9, shows twist lock locking pin 72 releasably rotatably attached or secured to rail tubing 24 via split ring 282. Twist lock locking pin 72 is vertically aligned via vertical axis 116 with aperture 114 on pin pad 112 of pin post 60 such that cone portion 117 at bottom end of twist lock locking pin 72 is inserted into aperture 114 and rotated (or twisted) about vertical axis 116 such that ends 115 of cone portion 117 lock underneath surface of pin pad 112, interlocking the pin posts of skid 14 with the twist lock locking pins, thereby securing the two together.

Once engaged (i.e., once cone portion 117 at bottom end of twist lock locking pin 72 enters aperture 114 on pin pad 112 of pin post 60), lever 119 is moved from a first position to a second position to lock the lower pin by rotating (or twisting) cone portion 117 about vertical axis 116 such that ends 115 of cone portion 117 lock underneath surface of pin pad 112, positively engaging the interfacing twist-lock. Bracket 120 lies between split ring 282 and twist lock locking pin 72. Bracket 120 has a curved configuration suitable to accommodate the curvature of split ring 282. The connecting point with pin post 58 is similar.

The present invention also includes an energy storage system. Reference is now made to FIGS. 10-19. Cradle or holder 150 and energy storage device 152, shown in FIG. 10, are the building blocks of the energy storage system of the present invention. Cradle 150 has a circular configuration and recessed portion 154 within the perimeter of cradle 150. Recessed portion 154 has aperture 156 therewithin (aperture 156 being in the center cradle 150). Aperture 156 has a quadrilateral configuration having sides 158 and 160 (the lengths) longer than ends 162 and 164 (the widths). At each end of the aperture are electrical contacts (positive and negative) which extend radially into the aperture from the inside perimeter surface of the cradle. For example, contacts 166 and 168 extend from inside perimeter surface 165 of cradle 150 toward aperture 156.

Additional contacts are mounted on the surface of the perimeter of the cradle. For example, contacts 172 (positive) and 174 (negative) are located on perimeter 170 of cradle 150. The contacts of the present invention are comprised of conductive material, such as nickel-plated metal, carbon steel, or copper. However, other conductive material may be used and still remain within the contemplation of the present invention.

Also shown in FIG. 10 is energy storage device or battery 152. Ends 176 and 178 of energy storage device 152 are positive and negative. Battery 152 completes the electrical circuit for and provides power (electrical) to the various components of solar power generation system 10. The energy storage device of the present invention is a battery, e.g., D cell battery, which may be a 12V lithium battery, alkaline battery, or nickel-cadmium battery. However, other comparable types of batteries may be used and still remain within the contemplation of the present invention.

Referring now to FIG. 11, a top perspective view of a portion of the energy storage system is shown. Cradle 150 has battery 152 secured within aperture 156 (not shown as battery 152 consuming volume of aperture 156) of recessed portion 154 of cradle 150. A plurality of tabs extends distally from top perimeter 170 of cradle 150. Plurality of tabs includes tabs 180, 182, 184 and 186. Several nooks are integrated within the bottom perimeter of the battery cradle. For example, nook 188 is on bottom perimeter surface 190. Additional nooks (not shown) are also present on bottom perimeter surface 190. The nooks are configured to receive the tabs, as, for example, when more than one cradle or holder is connected to another cradle or holder, as detailed further below. The battery holder in FIG. 11 is shown in a vertical configuration for illustrative purposes only but in use will be in a horizontal configuration.

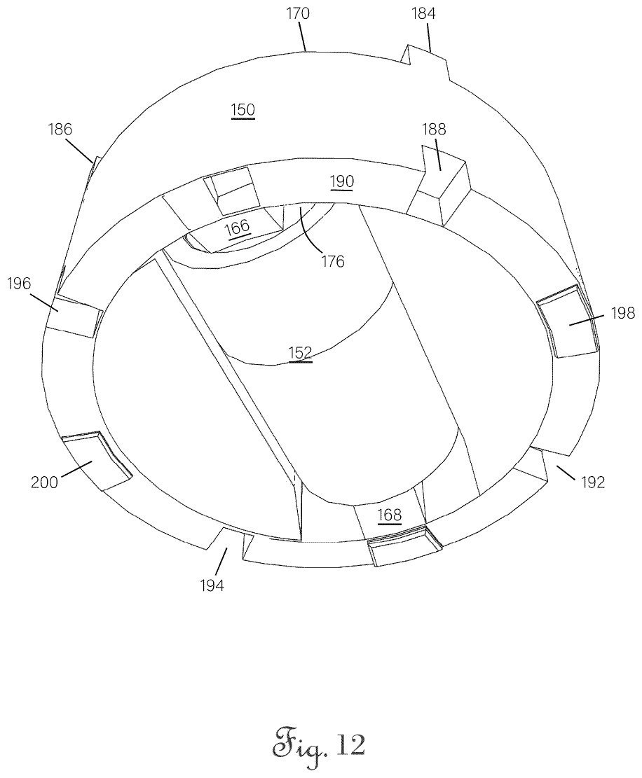

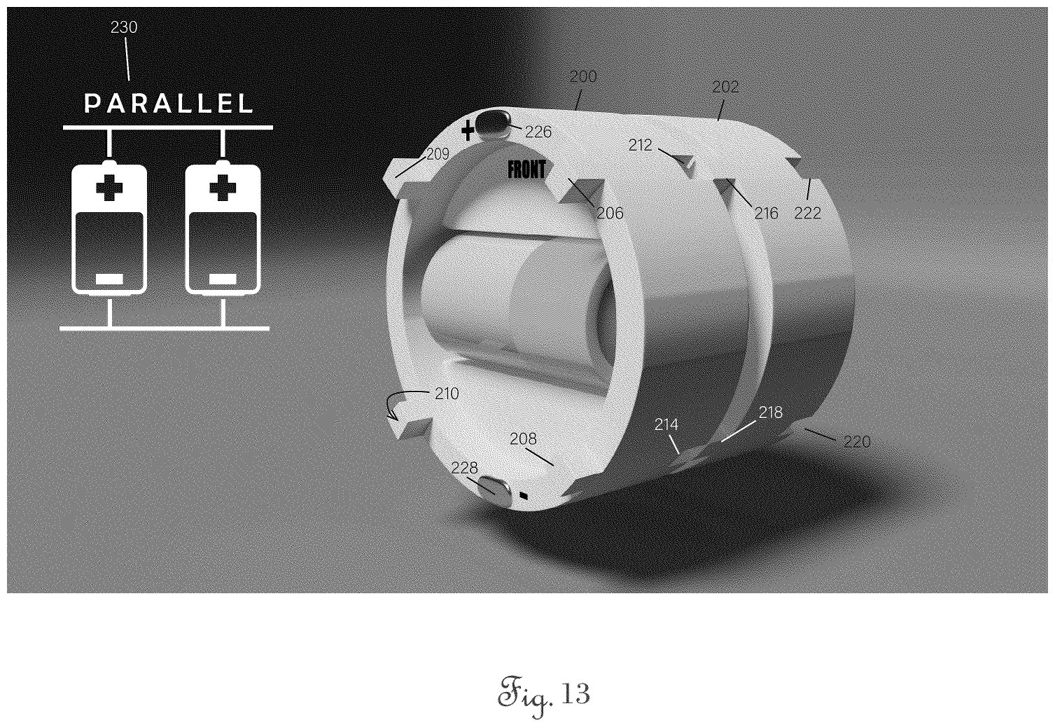

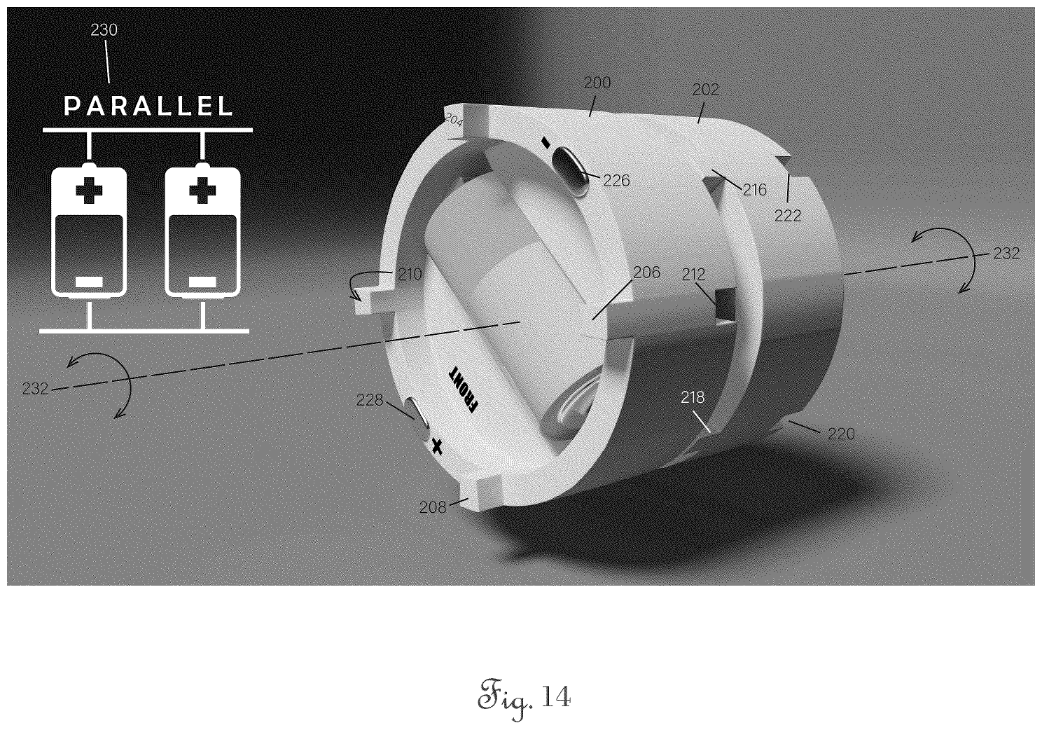

Referring now to FIG. 12, a bottom perspective view of a portion of the energy storage system is shown. Battery 152 is secured within cradle 150 with ends 176 and 178 (not shown) making contact with contacts 166 and 168, respectively.

Battery 152 and battery cradle or holder 150, combine, as discussed, to comprise a single unit (battery/battery holder) of the energy storage system of the present invention. However, more than one battery/battery holder unit may be electrically connected together. Turning now to FIGS. 13-18, battery/battery holder 200 has tabs 204, 206, 208 and 210 extending distally from front end 224, and nooks 212, 213, 214 and 215, of which only nooks 212 and 214 can be seen in FIG. 13. Battery/battery holder 202 has tabs 216, 217, 218 and 219, of which only tabs 216 and 218 (can be seen in FIG. 13), and nooks 220, 221, 222 and 223, of which only indentions 220 and 222 can be seen in FIG. 13.

Battery/battery holder 200 is physically and electrically connected to battery/battery holder 202. This is accomplished by aligning battery/battery holder 200 with battery/battery holder 202 such that nook 212 of battery/battery holder 200 aligns and mateably attaches with corresponding tab 216 of battery/battery holder 202, nook 214 of battery/battery holder 200 aligns and mateably attaches with corresponding tab 218 of battery/battery holder 202. Nooks 213 and 215 of battery/battery holder 200 similarly align and mateably attach with corresponding tabs 217 and 219 of battery/battery holder 202, respectively. The battery/battery holders are in a horizontal configuration, as shown in FIG. 13.

In addition, not only are the battery/battery holder electrically connected together, but they may be electrically connected in alternate embodiments. One embodiment would be in a circuit in parallel configuration. To accomplish this, and still referring to FIG. 13, battery/battery holders 200 and 202 are connected in the manner just described, such that the positive contact (not shown) of battery/battery holders 202 is in contact with the positive contact (not shown) of battery/battery holder 200 and the negative contact (not shown) of battery/battery holder 202 is in contact with the negative contact (not shown) of battery/battery holder 200, as shown in FIG. 13. This produces parallel circuit configuration 230.

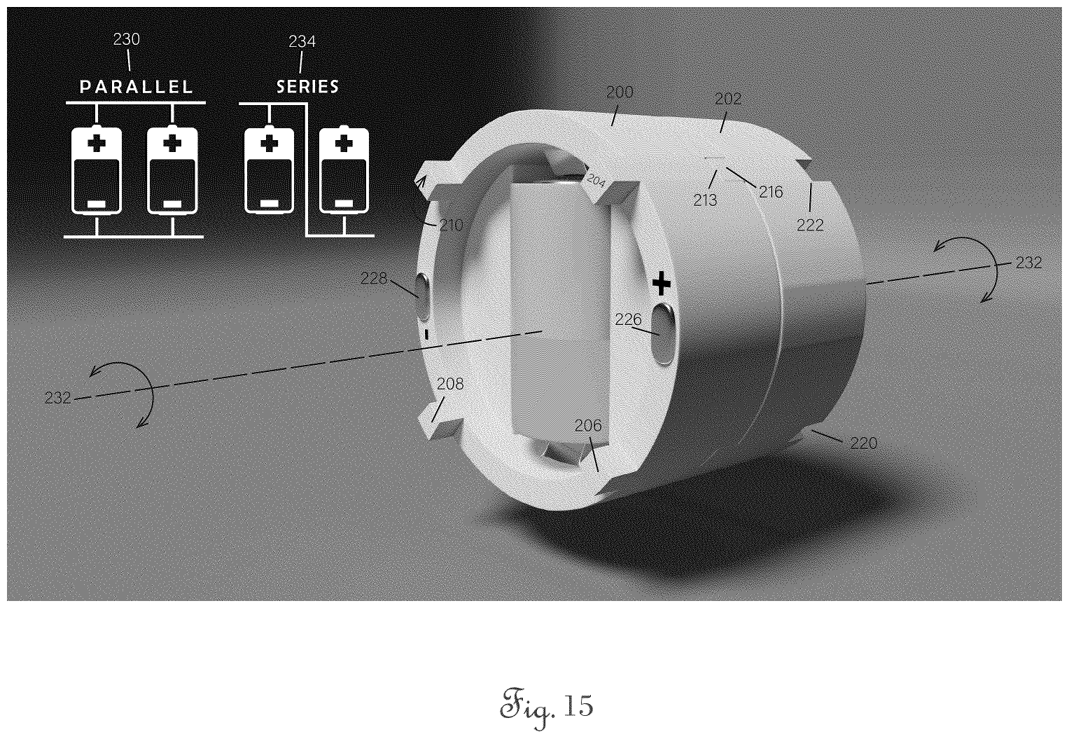

A second embodiment would be in a circuit in series configuration. To accomplish this, battery/battery holder 200 is rotated 90° about longitudinal axis 232 in either a left hand or right hand direction, as shown in FIG. 14. Once rotated 90° about longitudinal axis 232, for example, in a right hand direction, tabs 216 and 218 of battery/battery holder 202 aligns and mateably attaches with corresponding nooks 213 and 212 of battery/battery holder 200, respectively, as shown in FIG. 15. Nooks 214 and 215 of battery/battery holder 200 similarly align and mateably attach with corresponding tabs 219 and 217 of battery/battery holder 202, respectively. This produces series circuit configuration 234.

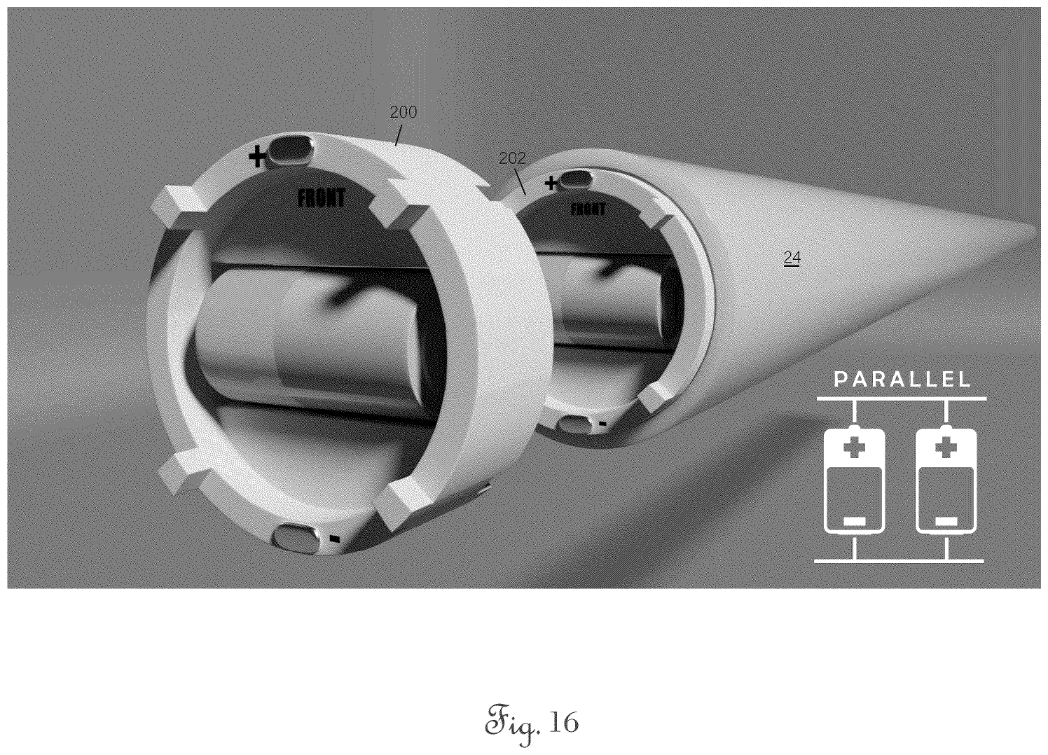

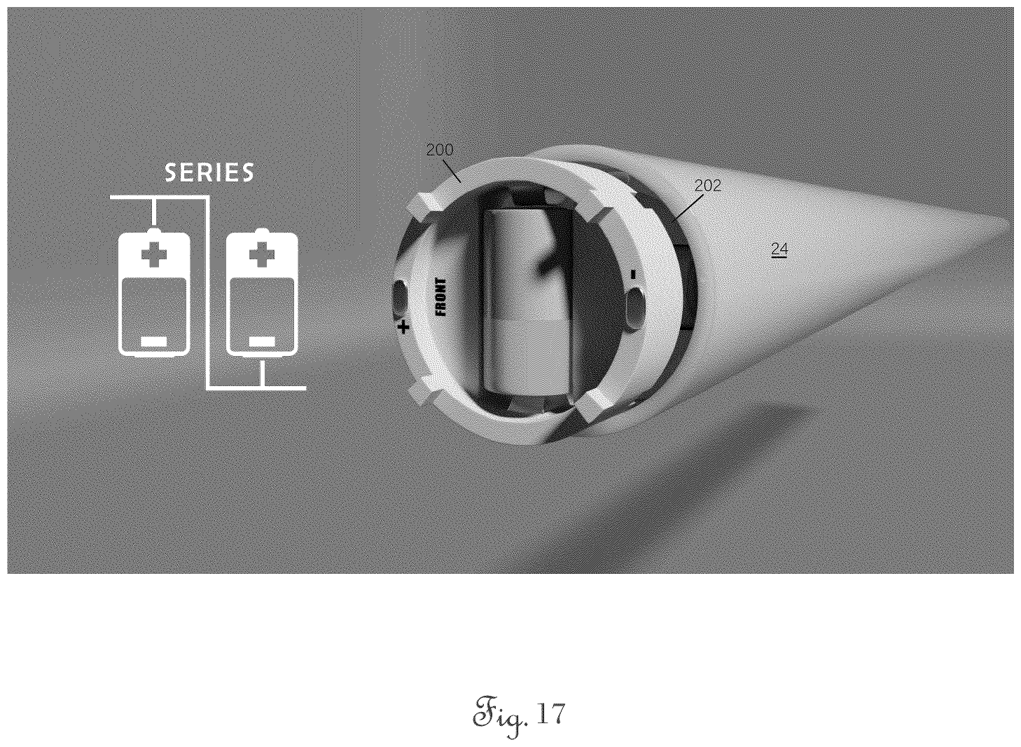

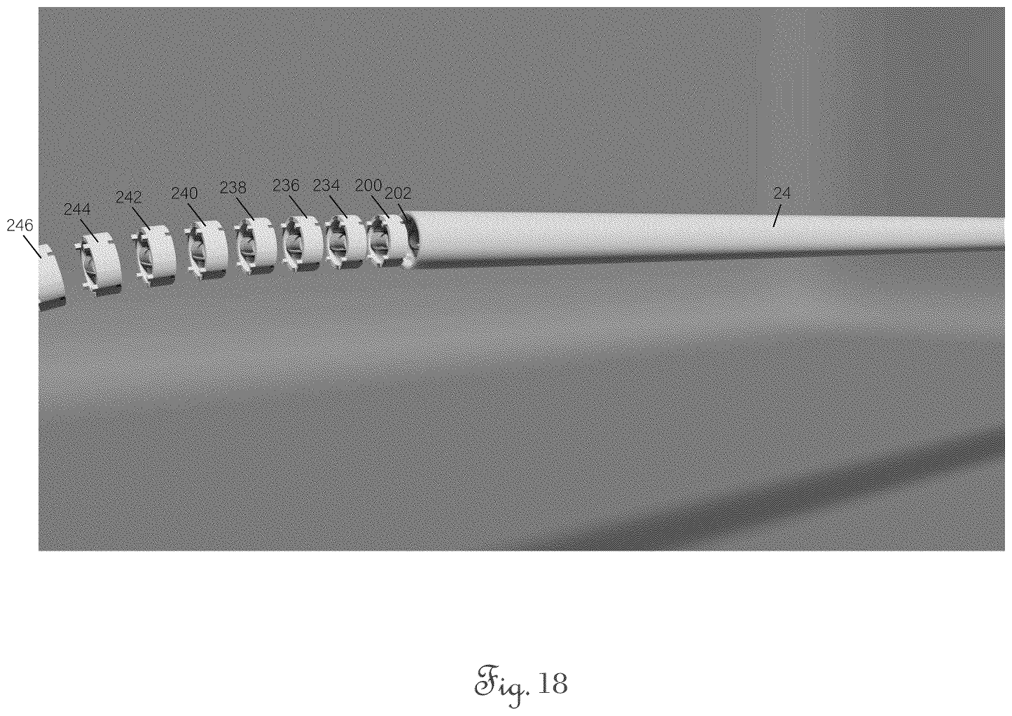

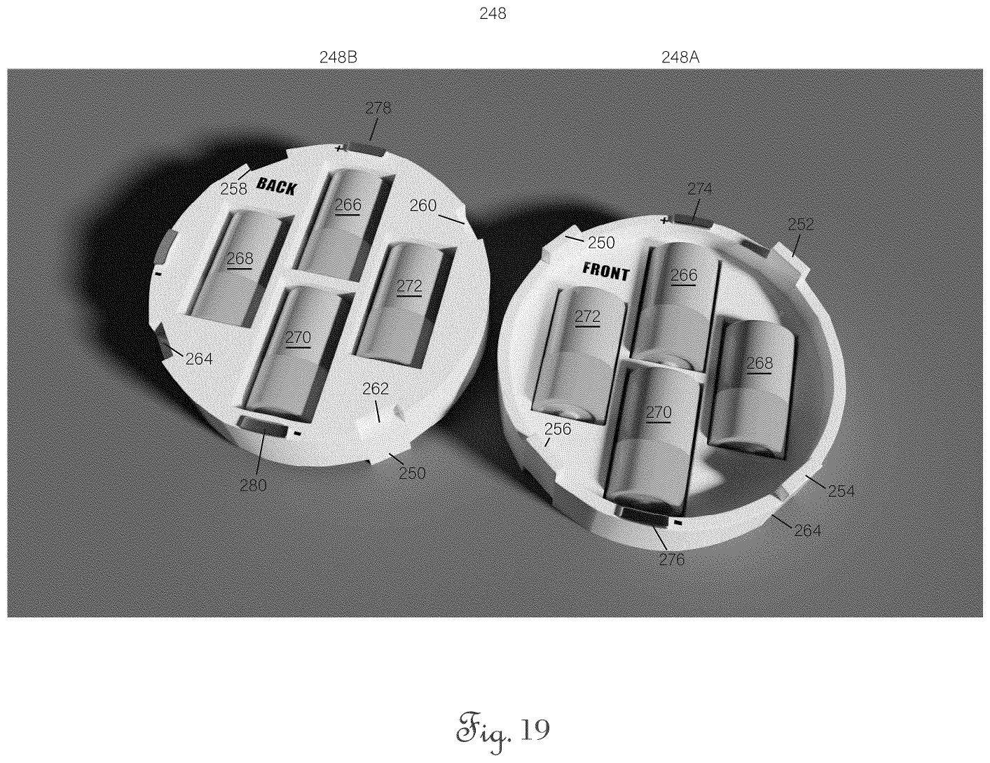

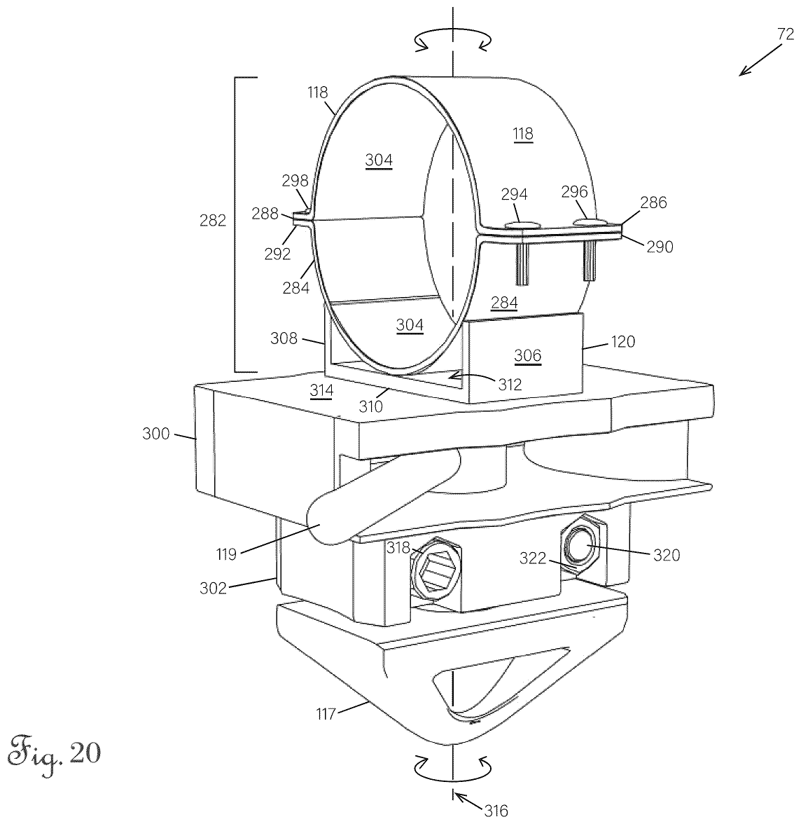

Turning now to FIGS. 16-18, battery/battery holders 200 and 202 are placed within rail tubing 24 sized to accommodate the dimensions of battery/battery holders, as shown in FIG. 16. Battery/battery holders 200 and 202 are physically and electrically connected to each other in either a parallel circuit configuration, as shown in FIG. 16, or in an alternative embodiment, as a series circuit configuration, as shown in FIG. 17. Several battery/battery holders may be placed within rail tubing 24 such that the number of battery/battery holders (e.g., battery/battery holders 234, 236, 238, 240, 242, 244 and 246) completely fills the length of rail tubing 24, as shown in FIG. 18. End caps 122 and 126 (not shown) (see, e.g., FIG. 4) fit within ends 124 and 128, respectively, of rail tubing 24. Array of solar panels 12 and rail tubing 24 with battery/battery holders therein are collectively called, “The Rail.”

While one embodiment of the present invention is a single battery (battery 152), in an alternative embodiment, multiple batteries may be used. Referring now to FIG. 19, in an alternative embodiment, multiple battery cradle 248 has front side 248A and backside 248B. Front side 248A accommodates up to four (4) batteries (batteries 266, 268, 270 and 272) with contact 274 (positive) and contact 276 (negative) and has tabs 250, 252, 254 and 256. Nooks 258, 260, 262 and 264 together with contact 278 (positive) and contact 280 (negative) are on back side 248B of multiple battery cradle 248, as shown in FIG. 19.

In the alternative embodiment of using a multiple battery cradle configuration, the rail tubing 24 would necessarily need to increase in size (both inner and outer diameters) to accommodate the larger dimensioned multiple battery cradles, e.g., increases of 4″, 6″ and 8″ OD. The setup is otherwise similar.

The advantage of using a multiple battery cradle over a single battery cradle is an extended use time of the present invention. In addition, additional power means that additional components may now be powered. These would include power consuming components which would not otherwise be powered in a single battery cradle configuration.

There may be an interest on behalf of the user to have the battery power storage system of the present invention in either a circuit in parallel configuration or a circuit in series configuration. These reasons include multiple phaseability and larger motor size capabilities. Further, parallel circuit configuration increases voltage, while series circuit configuration increases the amperage. As an example, in one embodiment there may be groups of battery/battery holders within the rail tubing. These groups may be in sets of 2 or sets of 4, with each set in a series configuration and tied together in parallel, the effect of which would be to increase the amperage while maintaining the voltage constant.

In an alternative embodiment, rather than having several individual battery/battery holders placed within rail tubing 24, as shown in FIG. 18, the present invention may use elongated, hemispherically configured, top and bottom complementary batteries, each having a semicircular cross-sectional profile which, when placed adjacent to one another, form a circular cross-sectional profile. The length of the top and bottom complementary batteries is such as to substantially fill the length of rail tubing 24. Both complementary batteries slide (one on top of the other) within the length of rail tubing 24.

In an alternative embodiment, slim frame exterior batteries may also be used to provide an external power source in the present invention. Referring now to FIG. 36, alternative embodiment 496 has rail tubing 498 upon which are attached braces 500, 502, 504, 506, 508 and 510. Rail tubing 498 contains additional braces not shown herein. Support 512 and 514 provide additional support for braces 500, 502, 504, 506, 508 and 510.

External batteries 516, 518, 520 and 522 are each mounted or attached to mounting plates 524, 526, 528 and 530. Mounting plates 524, 526, 528 and 530 are mounted or attached to rail tubing 498 at predetermined intervals along rail tubing 498. The present invention shows four (4) external batteries, two on either side of center of rail tubing 498.

External battery 516 is secured to mounting bracket 524. Two mounting plates, mounting plates 534 and mounting plate 540 (on one side of external battery 516) have L-shaped configurations and secures one side of external battery 516 to mounting bracket 524 via bolt 536 and washer 538 and via bolt 542 and washer 544, respectively. Two additional mounting plates (not shown) with their respective bolts and washers (not shown) similarly secure the opposite side of external battery 516 to mounting bracket 524. As such, a total of 4 mounting plates are used to secure external battery 516 to mounting bracket 524. Each of external batteries 518, 520 and 522 are attached to mounting plates 526, 528 and 530, respectively, which is then attached to rail tubing 498 in a similar fashion. Once mounted, there is a 1½ inch clearance between the bottom of rail tubing 498 and the top of the external battery.

As discussed herein, there are four (4) external batteries that can be used to provide an external power source to the present invention. These four external batteries 516, 518, 520 and 522 provide 100 amp hours at 48 volts which translates to a total of 4800 amp hours. Should more power be required, additional external batteries may be mounted or attached to the underside of mounting brackets 524, 526, 528 and 530 using the same bolts as previously described, such that the additional external batteries would lie directly opposite external batteries 516, 518, 520 and 522, separated only by mounting brackets 524, 526, 528 and 530, respectively. These now eight (8) external batteries provide double the power, or 9600 amp hours, than just the four (4) external batteries.

One advantage of using external batteries includes the ease by which they can be replaced. The user can go directly to the “bad” battery and replace same without having to remove all of the batteries to get to the “bad” one—which would be how a user would replace one of the internal batteries that is no longer functioning within the rail tubing. Another advantage is that the external batteries are located underneath the array of solar panels. This has the added benefit of providing protection for the external batteries against the elements and inclement weather, or the weather in general.

The external battery used in the present invention is a lithium iron phosphate (LiFePO₄) battery commercially available under the CYCLENPO brand by Cyclen Technology Co., Ltd. The dimension of the external battery is 3″×28″×18″. However, other comparable batteries may be used and remain within the contemplation of the present invention.

While the present invention in this embodiment depicts only four (4) external batteries, and optionally eight (8) external batteries (with four on top and four on bottom of the mounting brackets), additional external batteries may be mounted in similar fashion (top and bottom) along the length of rail tubing 498 for additional external power, if desired.

In addition, with the added external batteries, several configurations of batteries are now available and include just the internal individual battery/battery holders placed within rail tubing 24 (as discussed with respect to FIG. 18), or the internal batteries in a variety of configurations, including two (2) hemispherically configured halves running the length of rail tubing 24, as described above. Additional embodiments also include having one set of external batteries (e.g., just the top) with either just the internal individual battery/battery holders within the rail tubing, or with the hemispherically configured halves running the length of the rail tubing. Further embodiments may include having two sets of external batteries (top and bottom) with either just the internal individual batteries or the hemispherically configured halves.

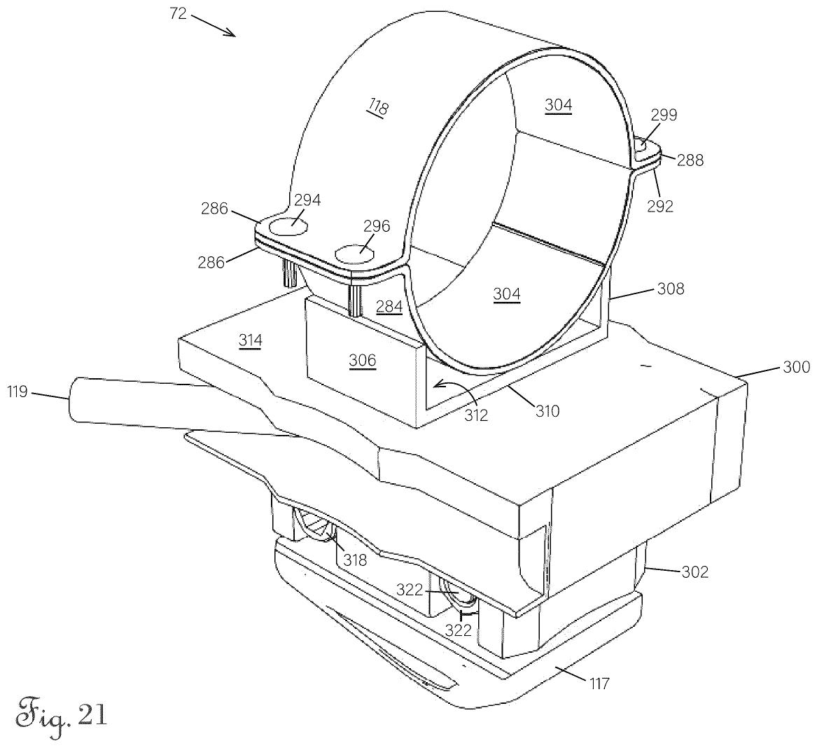

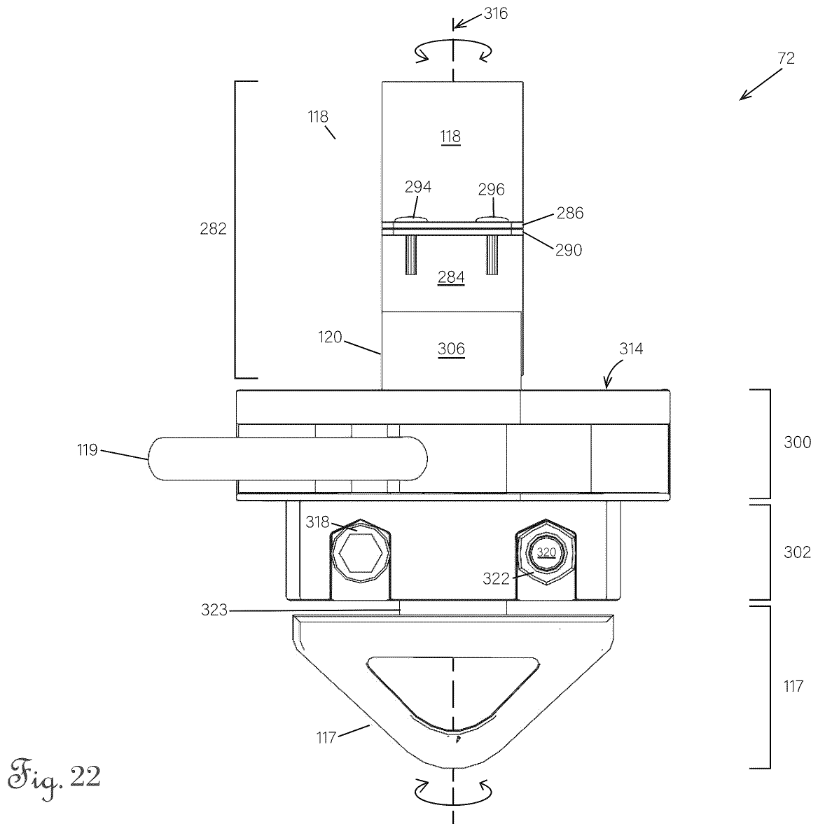

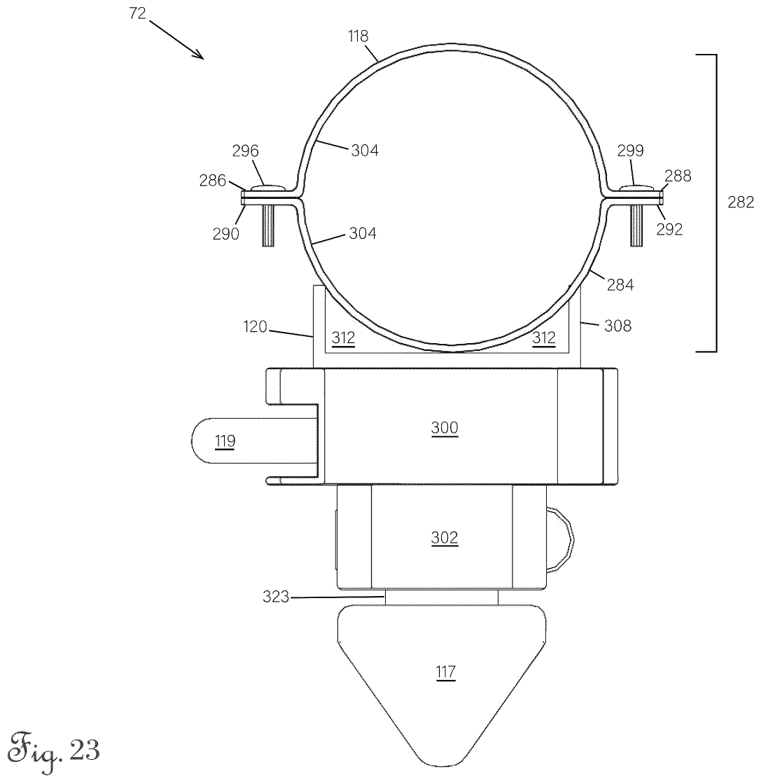

Twist lock locking pins and split rings are used to securely anchor rail tubing 24 to either skid 14 or alternatively, an ISO compatible container. Turning now to FIGS. 20-24, twist lock locking pin 72 is comprised of split ring 282, block 300, block 302 and cone portion 117. Split ring 282 is comprised of upper half ring 118 and lower half ring 284. Lip 286 extends distally from one end of upper half ring 118. Lip 288 extends distally from the opposite end of upper half ring 118. Lips 286 and 288 extend distally in opposite directions.

Lip 290 extends distally from one end of lower half ring 284. Lip 292 extends distally from the opposite end of lower half ring 284. Lips 290 and 292 extend distally in opposite directions. Apertures (not shown) traverse lips 286 and 288 of upper half ring 118 as well as lips 290 and 292 of lower half ring 284. The apertures of upper half ring 118 are aligned with the apertures of lower half ring 284. Fasteners 294 and 296 traverse lip 286 of upper half ring 118 and lip 290 of lower half ring 284. Similarly, on the opposite side, fasteners 298 and 299 (only fastener 298 of which can be seen) traverse lip 288 of upper half ring 118 and lip 292 of lower half ring 284. This thereby secures and holds upper half ring 118 and lower half ring 284 together and forms a complete ring.

Fasteners are used to secure upper half ring 118 and lower half ring 284 together to form split ring 282. For the added advantage of adjustability and multiple use of the split rings, the present invention uses bolts with corresponding washer (e.g., flat washer, lock washer, etc. . . . ). However, other types of fasteners, such as rivets and the like, may also be used to fasten the upper half ring and lower half ring together and still remain within the contemplation of the present invention.

In an alternative embodiment, a rubber or plasticized cushion (not shown) lines inside surface 304 of split ring 282 to provide a more robust grip on rail tubing 24 (not shown). Vibrations that may occur while rotating may also be minimized or eliminated providing further stability to the array of solar panels.

Split ring 282 is secured and anchored to bracket 120. Bracket 120 has 3 surfaces comprising flat side 306, flat side 308 and flat bottom surface 310. flat side 306, flat side 308 and flat bottom surface 310 define area 312 which accommodates and secures split ring 282. Split ring 282 is secured to bracket 120 via welding along contact points between lower half ring 284 of split ring 282 and flat side 306 of bracket 120, as well as lower half ring 284 of split ring 282 and flat side 308 of bracket 120.

Bracket 120 is secured to block 300 via welding. Flat bottom surface 310 of bracket 120 is welded to top surface 314 of block 300. Block 302 is positioned between block 300 and cone portion 117. Block 300 and 302 are attached via welding. Block 302 contains fastener 318 and fastener 320 which traverse the width of block 302 (from front to back). However, fastener 318 and fastener 320 traverse block 302 in opposite directions. For example, fastener 318 (e.g., bolt) would be threaded into block 302 starting from the front of block 302 with a corresponding nut (not shown) to engage and secure fastener 318 at the back of block 302. Fastener 320 would be threaded into block 302 starting from the back of block 302 with a corresponding nut 322 to engage and secure fastener 320 at the front of block 302, as shown in FIG. 20.

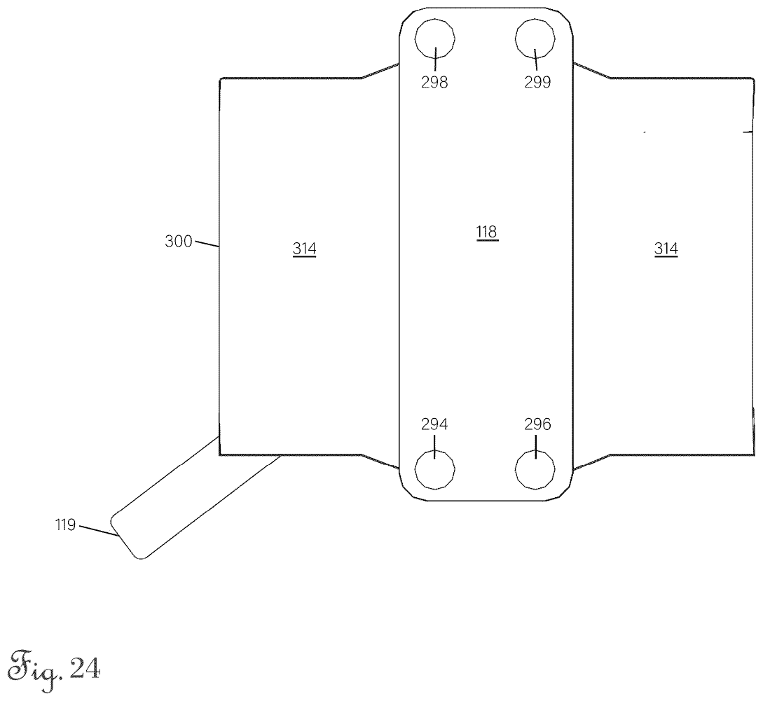

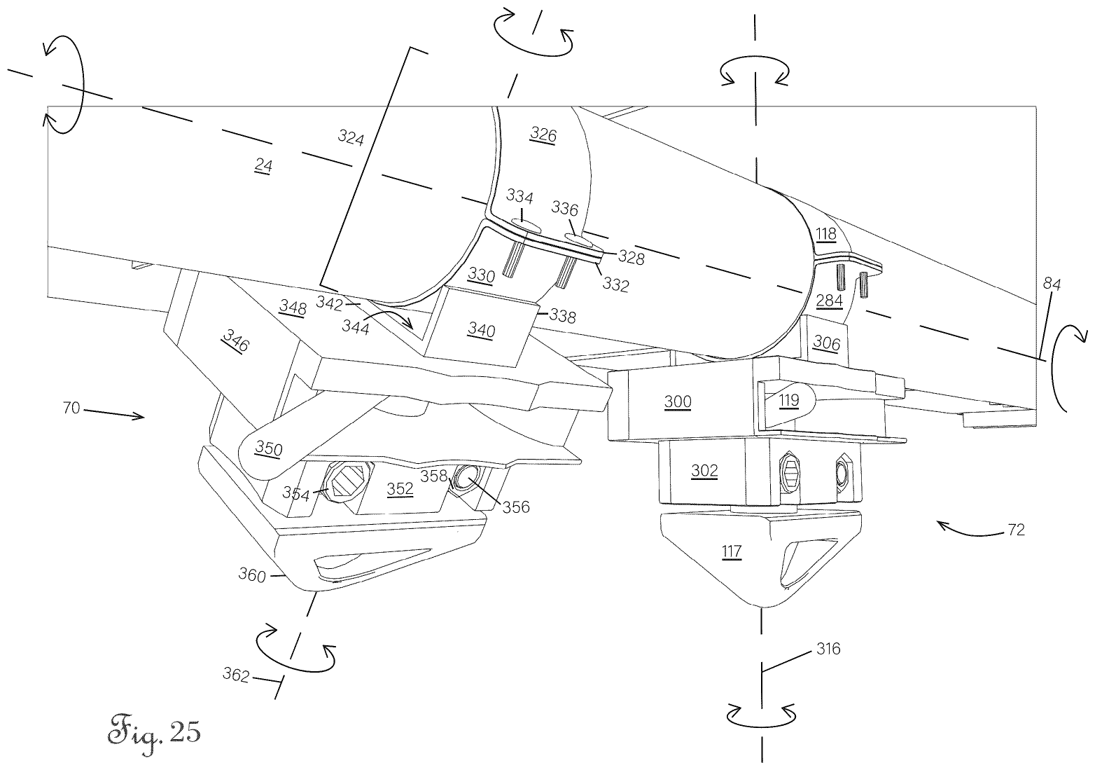

Cone portion 117 of twist lock locking pin 72 is the mechanism by which engagement between rail tubing 24 with array of solar panels 12, on the one hand, is engaged with and secured to either skid 14, or alternatively, an ISO compatible container. Block 300 has lever 119 used to change the configuration of cone portion 117. Lever 119 of block 300 may be moved from a first position to a second position. In doing so, lever 119 rotates shaft 323 (e.g., FIGS. 22 and 23) which causes cone portion 117 to twist or rotate about vertical axis 316. First position and second position of lever 119 correspond to engaged and non-engaged configurations, respectively, of twist lock locking pin 72.

Twist lock locking pin 72 was used for illustrative purposes. However, all twist lock locking pins in the present invention are described and function similarly.

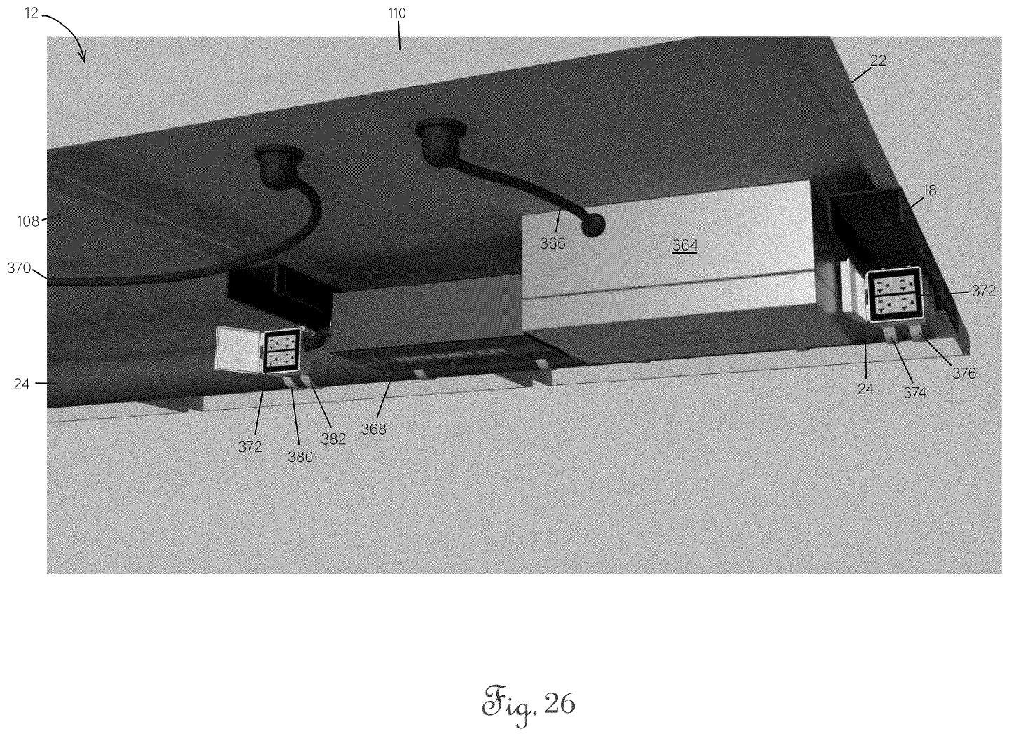

Turning now to FIG. 25, a plurality of twist lock locking pins is shown attached to the rail tubing of the present invention. Twist lock locking pin 72 was previously described in detail above. A second twist lock locking pin, twist lock locking pin 70, may also be secured to rail tubing 24 via split ring 324. Split ring 324 is comprised of upper half ring 326 having lip 328 and lower half ring 330 having lip 332. Fasteners 334 and 336 secure lips 328 and 332 together. Similar lips and fasteners are also included on the opposite side of split ring 324, however, those are not shown in FIG. 25. The securing on both sides of upper half ring 326 to lower half ring 330 about rail tubing 24 secures split ring 324 in place.

Split ring 324 is secured to bracket 338 via welding. Bracket 338 is secured to block 346 via welding between flat bottom surface 342 of bracket 338 and top surface 348 of block 346. Bracket 338 also has flat side 340 and a back surface (not shown) which together with flat bottom surface 342 define area 344 within bracket 338 which accommodates split ring 324 therein.

Block 346 contains lever 350 which, similar to lever 119 of block 300 of twist lock locking pin 72, moves from a first position to a second position. Block 352 is secured to block 346 via welding. Block 352 contains fasteners that run the width of block 352—similar to fasteners within block 302. Cone portion 360 is movably attached to block 352 via a shaft (not shown).

Still referring to FIG. 25, cone portion 360 is the mechanism by which engagement between rail tubing 24 with array of solar panels 12, on the one hand, is engaged with and secured to either skid 14, or alternatively, an ISO compatible container. Block 346 has lever 350 used to change the configuration of cone portion 360. Lever 350 of block 346 may be moved from a first position to a second position. In doing so, lever 350 rotates about a shaft (not shown; but see, e.g., FIGS. 22 and 23) which causes cone portion 360 to rotate about vertical axis 362. First position and second position of lever 350 correspond to engaged and non-engaged configurations, respectively, of cone portion 360.

The tilt optical angle for the present invention is 35°. Twist lock locking pins 70 and 72 may be adjusted to secure the best fit around rail tubing 24, and thus the optimal angle of array of solar panels 12. Adjustment is accomplished by loosening the fasteners (e.g., 334, 336) that secure upper half rings 326 and 118 to lower half rings 330 and 284, respectively, and rotating twist lock locking pins 70 and 72 about longitudinal axis 84 until the desired angles are reached. The preferred angle is 35° relative to the vertical axis (e.g., vertical axis 362 for twist lock locking pin 70 and vertical axis 316 for twist lock locking pin 72).

The split rings of the present invention are adjustable and may accommodate rail tubings of different sizes. For example, if an alternative embodiment of the larger multiple battery cradle is used, the rail tubing would necessarily need to increase in size as well. The split ring in the present invention can accommodate this increase in size without any reduction in performance and robustness. An key advantage is the split ring fasteners attached to the twist lock. To tighten the split ring fasteners, an impact wrench or comparable tool may be used.

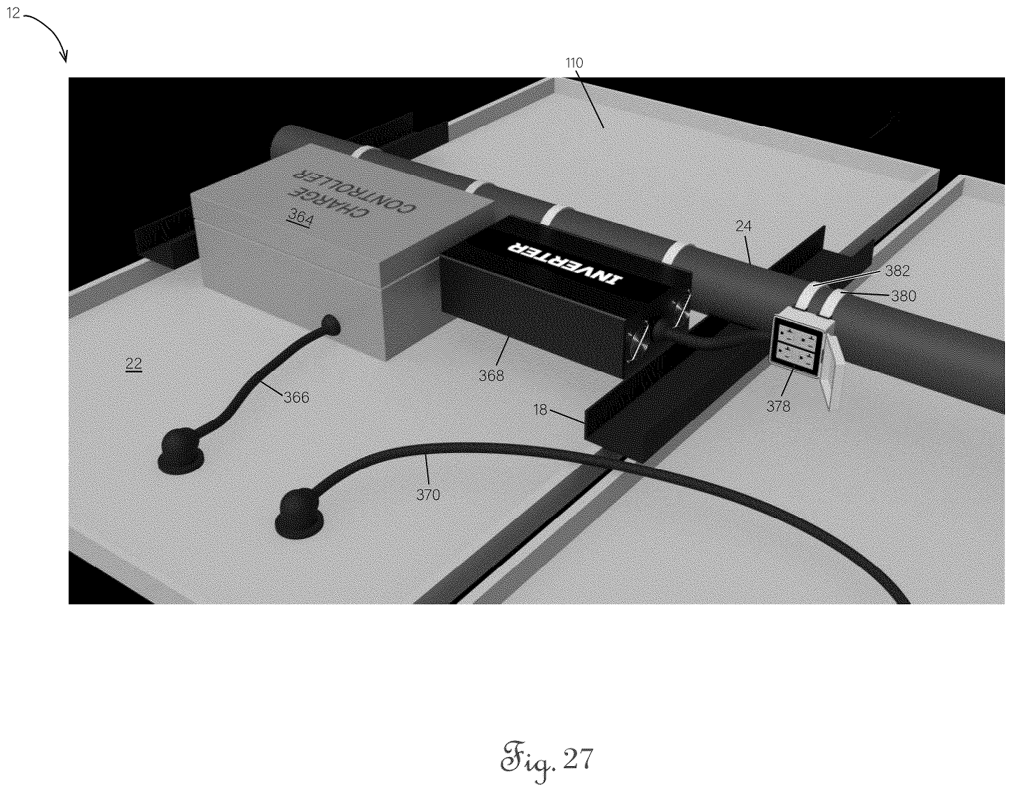

There are several other electrical components that facilitate distribution of power within and throughout the portable solar power generation system. The Rail is fitted with these components which include a combiner box, a charge controller, an inverter and normal 110 and/or 240 volt plug receptacles or electric outlets allowing for instant power to a site upon delivery. Turning now to FIGS. 26 and 27, a partial view of array of solar panels 12 is shown, to include solar panels 108 and 110. Charge controller 364 is attached to bottom surface 22 of solar panel 110 by one of various means including through the use of adhesive, fasteners, hook and loop material or the like. Charge controller 364 electrically connects to the plurality of energy storage devices, e.g., batteries, within battery cradles that make up an array of battery/battery holders nested within rail tubing 24, and to the load (e.g., household electronics, such as lights, air conditioning, fans, etc. . . . ), supplying power to the plurality of energy storage devices and/or the load such that a consistent charge level is maintained. See, e.g., FIG. 18. In short, charge controller 364 controls and regulates power to the energy storage devices within rail tubing 24 and to the load.

Cable 366 is connected to bottom surface 22 of solar panel 110 at one end. At the opposite end, cable 366 is connected to charge controller 364. Cable 370 is also connected to bottom surface 22 of solar panel 110 at one end. At the opposite end, cable 370 connects to the adjacent solar panel. Thereafter, this pattern (where each cable end is connected to the adjacent solar panel) is repeated along the array of solar panels until the last solar panel in the array is reached, at which point the remaining cable of the last solar panel in the array is connected back to charge controller 364. As solar panel 110 creates an electrical current from the received sunlight (i.e., photovoltaic effect), the electrical current is passed to combiner box (not shown) inside of charge controller 364 via cable 366. Combiner box is electrically connected to inverter 368 by way of charge controller 364. Inverter 368 converts received direct current (DC) from charge controller 364 to alternating current (AC) which is the form of power usable by household electronics, such as lights, air conditioning, fans, etc., Inverter 368 is attached to bottom surface 22 of solar panel 110 by one of various means, including through the use of adhesive, fasteners, hook and loop material or the like.

Still referring to FIGS. 26 and 27, outlet 372 is secured to rail tubing 24 via ring clamps 374 and 376. Outlet 372 may be a 110 or 240 volt plug receptacle. A second outlet, outlet 378 may also be included and attached to rail tubing 24 via ring clamps 380 and 382.

Each solar panel in array of solar panels 12 contains two (2) cables as just described. Each Rail will have twelve (12) solar panels and a double bracket in the center. Including the single ends, there are a total of 14 supports brackets. The longer bracket will be 48″ and inverted under a center lifting space to secure mounting points for tracker system 16.

Regarding the process of lifting the solar power generation system, solar power generation system 10 is configured to be balanced once assembled. This is to say, that when the present invention is lifted from the middle (or center) of the rail tubing, there is minimal movement or sway from the left and right side with respect to the center of rail tubing 24. This is because the lifting point at the center of solar power generation system 10 is centrally balanced. As such, the present invention may be lifted using various equipment, including a tele handler, excavator or other lifting machine together with a strap, e.g., nylon strap.

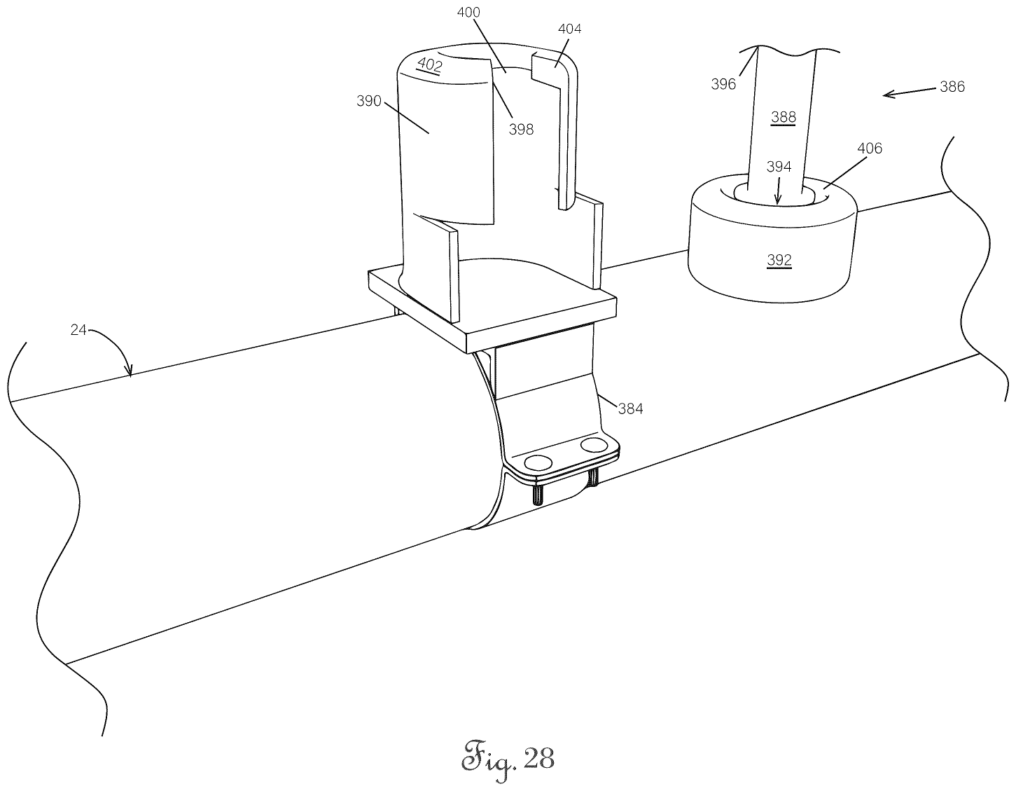

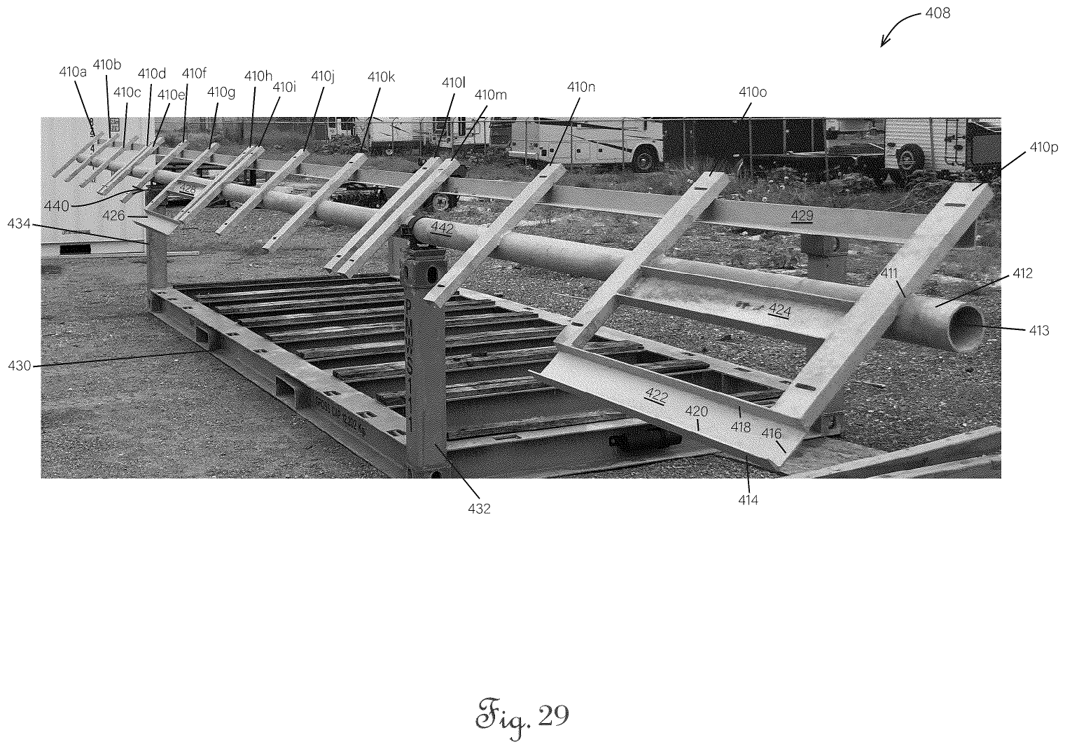

In an alternative embodiment, a ball and harness is used. To lift the present invention in this embodiment, a crane is required. Referring now to FIG. 28, the lifting process of solar power generation system 10 is facilitated through the use of lifting ball and harness 386 attached to ring claim 384 fitted around rail tubing 24. Shaft 388 of ball and harness 386 is one-inch outer diameter (1.0″ OD). Shaft 388 slides easily within the 4-5 inch clearance between solar panels. U-configured member 390 is attached to (e.g., welded) and extends distally from ring clamp 384 fitted around rail tubing 24. Ball 392 is at bottom end 394 of shaft 388 of ball and harness 386 (viewed in a vertical configuration). At opposite end 396 of shaft 388 is an “eye” (not shown). A crane hook (not shown) hooks onto the eye to lift up on lifting ball and harness 386.

U-configured member 390 is hollow and has opening 398 that expands into aperture 400 which may accommodate ball 392 of ball and harness 386. To do so, ball 392 is lowered toward rail tubing 24 towards U-configured member 390. Ball 392 is then inserted into U-configured member 390 via opening 398 until ball 392 is within aperture 400. Top surface 402 of U-configured member 390 creates ledge 404 against which top surface 406 of ball 392 “catches” due to tension created when a crane is lifting ball and harness 386 when ball 392 is within aperture 400 of U-configured member 390. The solar power generation system may now be lifted and moved from one location to another. Once moved to the desired location, the crane would lower ball and harness 386 such that there is no further contact between top surface 406 of ball 392 and ledge 404 of U-configured member 390 and ball 392 may be released from aperture 400 of U-configured member 390.

In an alternative embodiment, counterweights, e.g., weights, sandbags, or the like, may be installed along rail tubing 24 at various strategic positions for additional balance during lifting by a crane. The weight of the rail tubing and solar panels is approximately 950 lbs. The skid weighs approximately 1000 to 1100 lbs.

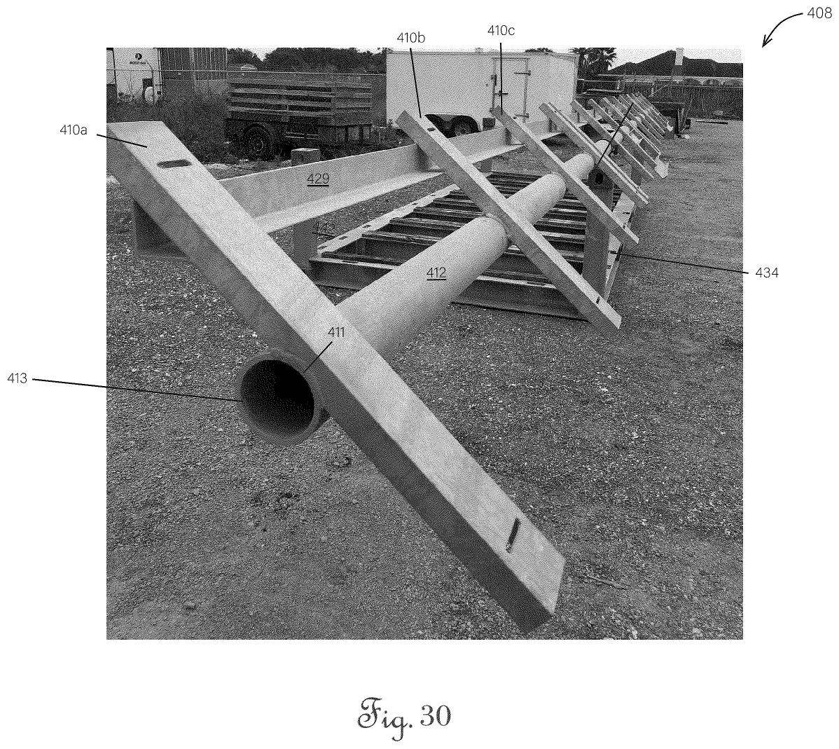

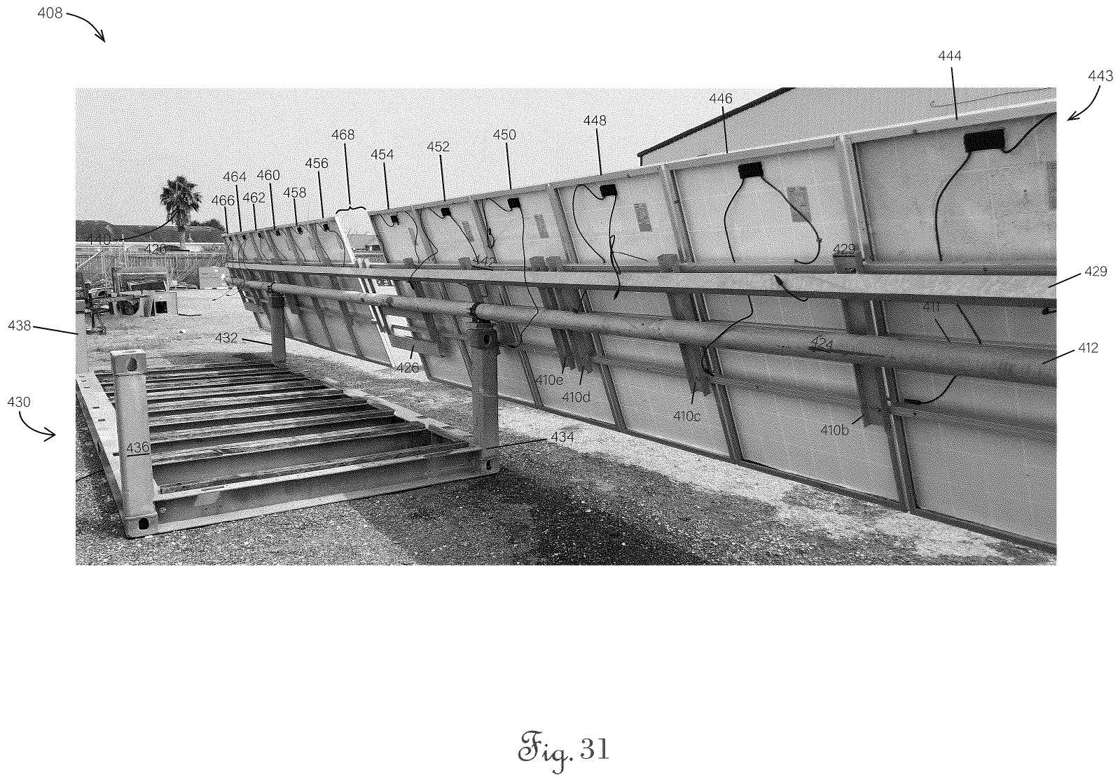

In an alternative embodiment, two arrays of solar panels may be mounted on a skid having four (4) pin posts instead of two (2) pin posts, as described above. Turning now to FIGS. 29 and 30, the assembly of dual mounted arrays of solar panels in an alternative embodiment of solar power generation system 408 is shown. Support brackets 410a-410p are secured to rail tubing 412 via welding at predetermined intervals along the length of rail tubing 412. Double support brackets (e.g., 410d and 410e, 410h and 410i, 410l and 410m) are used to provide additional strength and reinforcement to the plurality of support brackets as they support the weight of several solar panels that make up the array of solar panels (not shown). Support brackets 410a-p have inwardly curved portion 411 to accommodate the curvature of railing tubing 412, as shown in FIGS. 29 and 30.

Horizontal brace 414 is attached to support brackets 410o and 410p at one end of support brackets 410o and 410p. Horizontal brace 414 adds additional strength and reinforcement to the plurality of support brackets. Horizontal brace 414 is composed of three sides 416, 418 and 420. When a solar panel (not shown) is attached to support brackets 410o and 410p, the solar panel forms a fourth side (not shown) defining area 422 of horizontal brace 414. Once the array of solar panels is mounted on the plurality of support brackets, any electronics, wiring, and the like may be placed in area 422 to keep same out of the elements (e.g., rain) as well as improve the aesthetics of the present invention (as opposed to having wires just hanging loose).

A second horizontal brace, horizontal brace 424, may also be included between support brackets 410o and 410p adjacent to rail tubing 412 (i.e., closer to the centers of support brackets 410o and 410p). Otherwise, horizontal brace 424 is described and functions similar to horizontal brace 414. Horizontal brace 426 is similarly attached to support brackets 410g and 410h at one end of support brackets 410g and 410h. Horizontal brace 426 otherwise is described and functions similar to horizontal brace 414.

Horizontal brace 428 is similarly attached between support brackets 410g and 410h adjacent to rail tubing 412 (i.e., closer to the centers of support brackets 410g and 410h). Horizontal brace 428 otherwise is described and functions similar to horizontal brace 424.

Support 429 is attached to (via welding) support brackets 410a-p and runs the length of rail tubing 412. Support 429 is configured as having two 3″×3″ perpendicular sides (90°) comprised of iron or other robust metal or metal alloy. The extending ends are welded to support brackets 410a-p such that a side profile of same has a triangular configuration. An additional advantage of this configuration is that the hollow area of the triangular configuration formed may be used as a conduit to run wiring therethrough, avoiding the use of unsightly zip ties which can weather and break.

A plurality of battery/battery holders physically and electrically connected to each other in either a parallel or series circuit configuration are placed within aperture 413 of rail tubing 412 such that they fill the length of rail tubing 412. (See, e.g., FIGS. 16-18). End caps (not shown) may then be fitted at either end of rail tubing 412.

Skid 430 has pin posts 432, 434, 436, and 438, each of which are described and function similar to pin posts 58 and 68, previously described (see, e.g., FIGS. 8, 9 and 25). Rail tubing 412 (with attached support brackets 410a-p) are removably engaged with skid 430 via twist lock locking pins 440 and 442, as shown in FIG. 29.

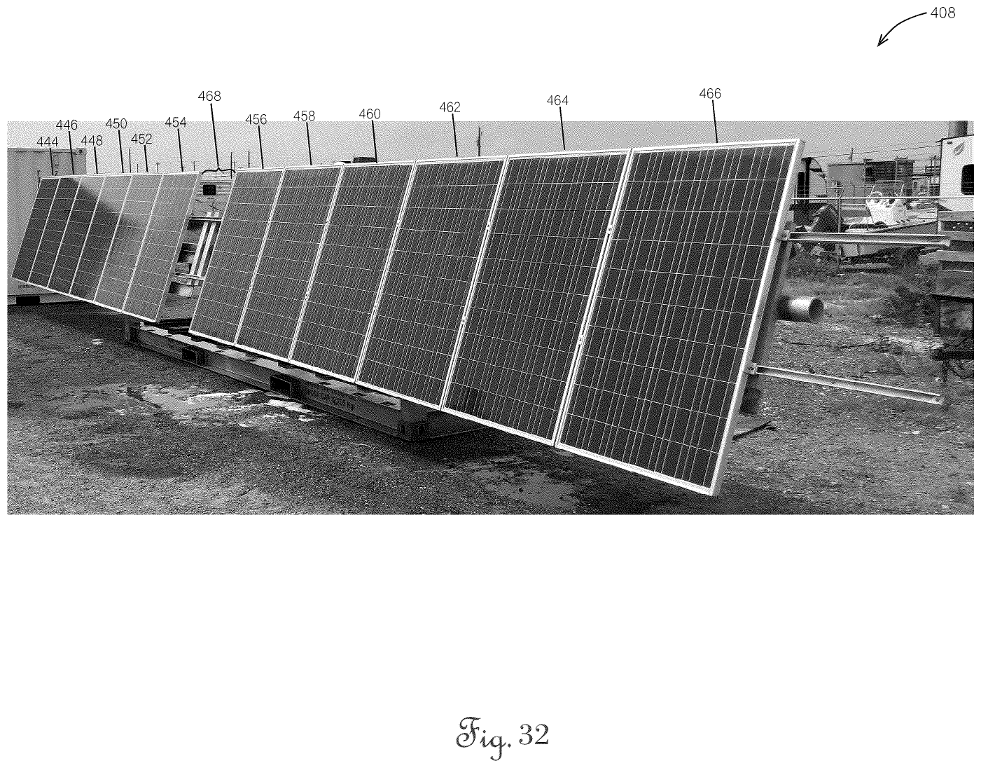

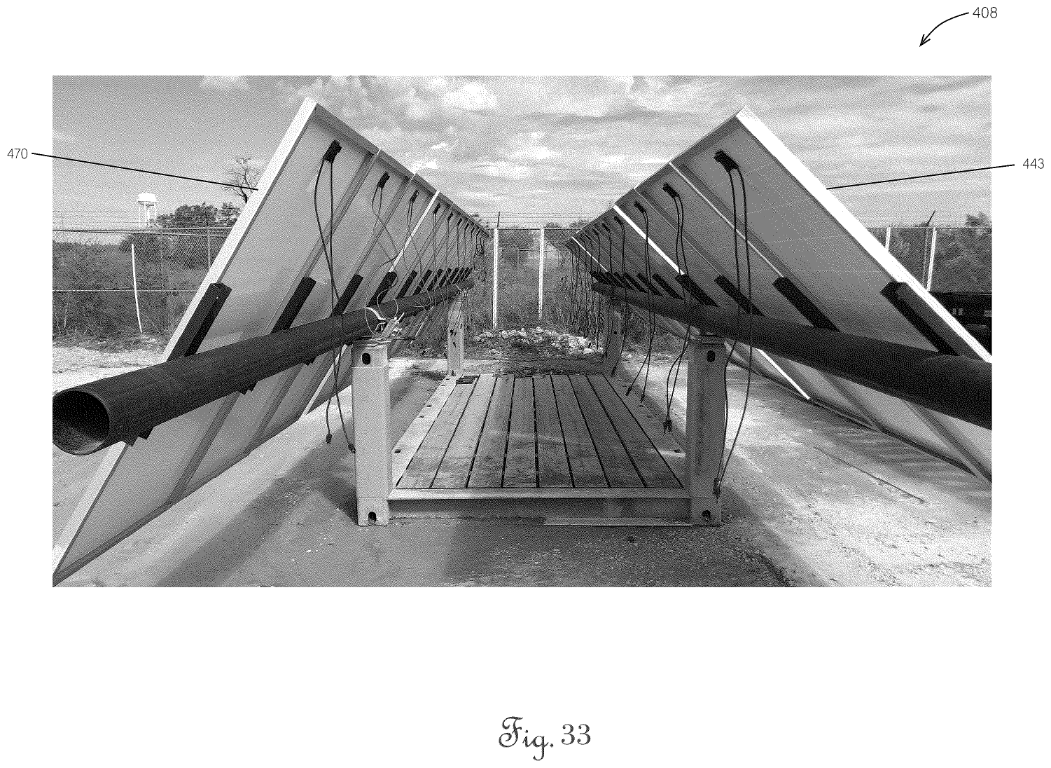

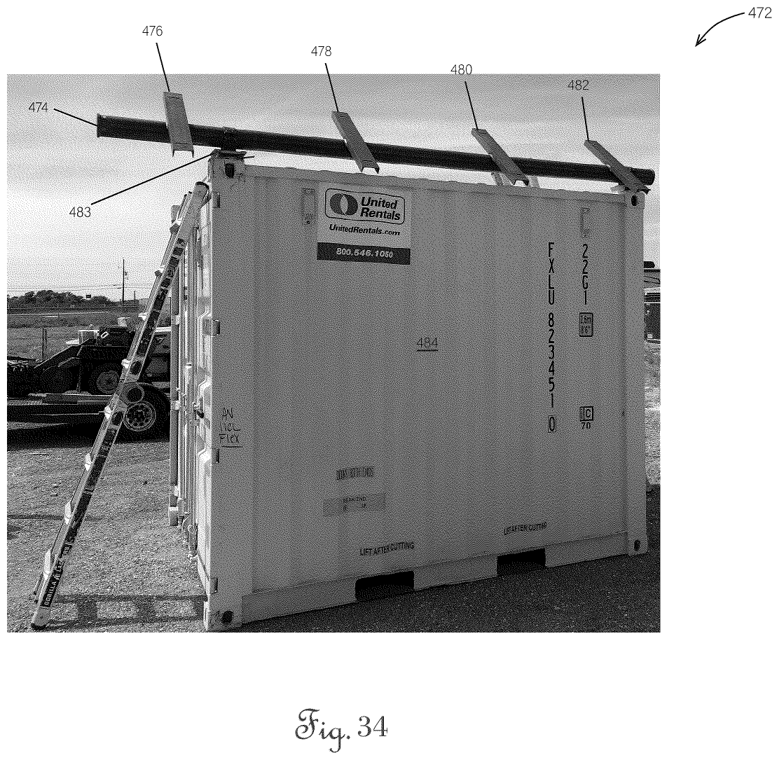

Turning now to FIG. 31, the back (or bottom side, depending on orientation) of array of solar panels 443 (comprised of solar panels 444, 446, 448, 450, 452, 454, 456, 458, 460, 462, 464 and 466) is shown. Array of solar panels 443 is secured to rail tubing 412 via support brackets 410a-p using fasteners, such as nuts and bolts like. Gap 468 is located between solar panel 454 and solar panel 456 in array of solar panels 443. Portion of rail tubing 412 exposed within gap 468 is considered the lifting center of the array of solar panels 443. In an alternative embodiment, the ball and harness used for lifting and moving the present invention, as described above with respect to FIG. 28 is located here. FIG. 32 shows the front side (or top side, depending on orientation) of array of solar panels 443. FIG. 33, shows array of solar panels 443 and array of solar panels 470 (dual mounted on one skid) in an alternative embodiment of the solar power generation system of the present invention.

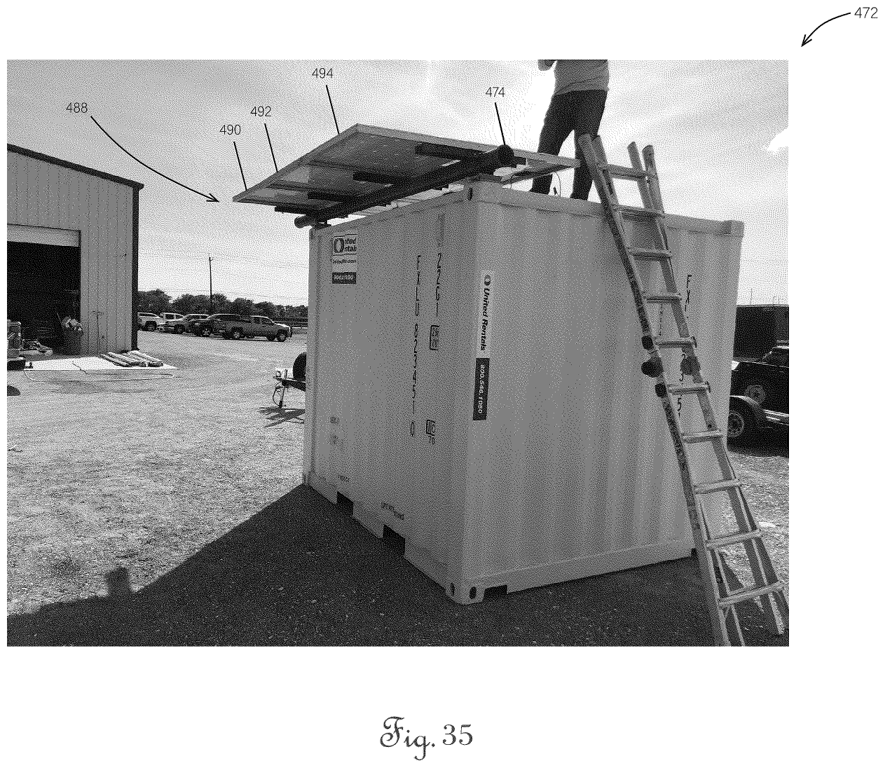

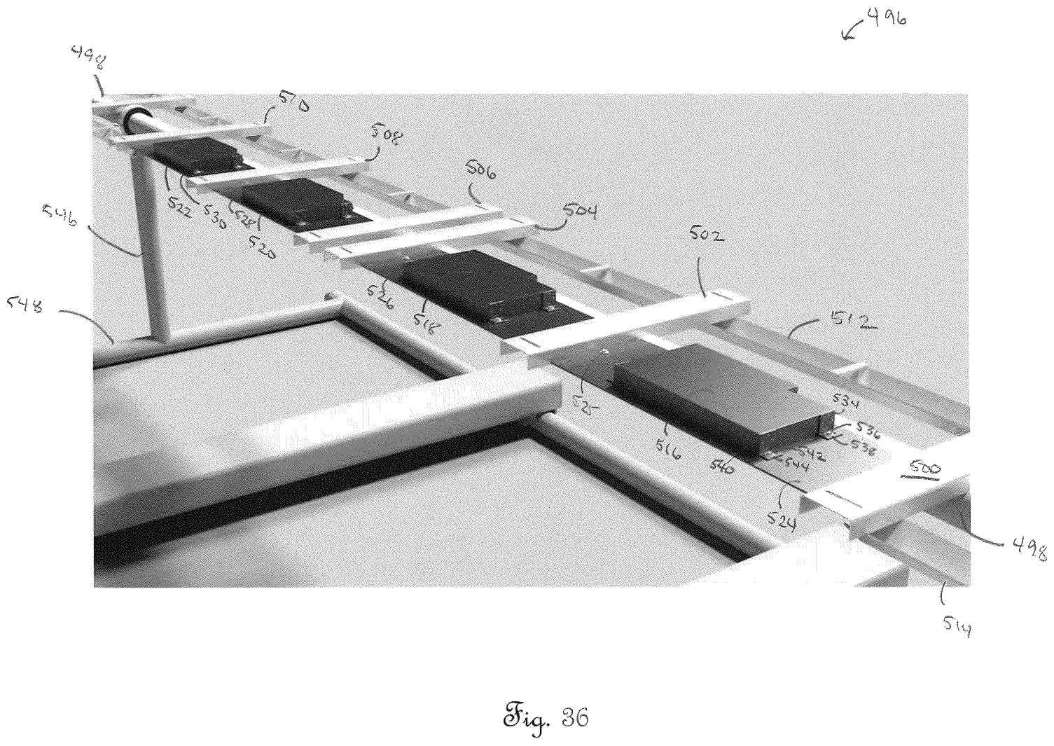

FIGS. 34 and 35 show a similar configuration of an alternative embodiment using either a single or a double array of solar panels having a reduced number of solar panels engaged or secured to an ISO compatible container of a reduced size of 8 ft. by 10 ft. (a “mini” ISO compatible container). For example, for a single array of solar panels, support brackets 476, 478, 480 and 482 are secured (e.g., fastened with nuts and bolts) to rail tubing 474 which is engaged and secured to mini ISO compatible container 484 via twist lock locking pins 483 and 485 (FIG. 35) at two of the four ISO compatible block corners (e.g., FIG. 2). Array of solar panels 488 comprising solar panels 490, 492 and 494 and then secured to rail tubing via fasteners, such as nuts and bolts. In the alternative embodiment having a second or double array of solar panels, a similar process is followed to secure the second array of solar panels (not shown) to the remaining two ISO compatible block corners.

Alternative embodiment of solar power generation system 408 (and alternative embodiment 472) provides several additional features and advantages over a single solar power generation system 10.

Cooling and Shade. The heat in Texas, can become unbearable during the summer months. It is not uncommon for a container to get to 120° F. in Texas heat because of direct heat. The present invention can run an air conditioner. For example, a single mounted array of solar panels can produce 5 kilowatts of power, whereas such alternative embodiment (double mounted) produces 8 kilowatts of power. Either is sufficient to power all household components and appliances, including a mini-air conditioner and lights. The present invention may also be used to power a heater in the event the weather is a bit cooler.

In addition, if either singly or doubly mounted on an ISO compatible container (either standard size or mini sized), the solar panels extend past the perimeter of the base of the skid. If mounted on a container, the solar panels extend past the perimeter of the container. In either instance, the present invention provides much needed shade in especially hot Texas summers. The configuration of the solar panels further allows wind to blow between the panels providing for additional cooling.

Safety. The present invention may be installed the top of an ISO compatible container or on top of a skid attached to the top of an ISO compatible container. There is an inherent theft deterrent in this configuration because the present invention is stored 14 feet in the air. In inclement weather, the container, now fully functional and powered by the present invention, can serve as an instant shelter from the elements, including heat, rain and inclement weather.

Stackable. Up to two (2) solar power generation systems may be stacked on top of skids.

Portability. The present invention is portable. Once assembled, the present invention may be moved from one location to another.

Community. The present invention may also be interconnected such that several solar power generation systems are in electric communication and may be set up near a community and synergistically generate power to scale. The surrounding community or communities can then tie into and consume this power.

The tracker of the present invention increases solar radiance by 20-30%. A standard fixed panel provides approximately 50% sunshine because the panel does not move. A fixed panel has an angle in the range of 35-45 for 5 hours. However, placing a panel on a tracker, as in the present invention, extends the time that the solar panel is exposed to direct sunlight for up to 6 hours because the panel is moving with the sun.

The skid and rail of the present invention are comprised of steel, and, in particular, galvanized steel to prevent or minimize rusting of the battery containers. However, other robust material may also be used and still remain within the contemplation of the present invention. In an alternative embodiment, the skid would also be galvanized steel but with additional paint such as an industrial strength high gloss polyurethane paint commercially available by DuPont under the Imron® brand.

The present invention has applicability in residential, commercial and power utility grids, solar farms, construction sites, disaster sites after a natural catastrophe took place and there is urgent need for power, and other areas where power is not generally accessible.

The various embodiments described herein may be used singularly or in conjunction with other similar devices. The present disclosure includes preferred or illustrative embodiments of specifically described apparatuses, assemblies, and systems. Alternative embodiments of such apparatuses, assemblies, and systems can be used in carrying out the invention as described herein. Other aspects and advantages of the present invention may be obtained from a study of this disclosure and the drawings.

I claim:

1. A portable solar power generation system comprising:
a solar assembly; and
a tracker assembly movably connected to said solar assembly.

2. The portable solar power generation system, as recited in claim 1, wherein said solar assembly comprises:
a cylindrical member;
a plurality of solar panels mounted to said cylindrical member;
a plurality of supports attached to said plurality of solar panels;
at least two split rings affixing said plurality of solar panels to said cylindrical member;
at least two blocks configured to receive corresponding at least two split rings; and
a plurality of power storage devices electrically connected to said plurality of solar panels;
a combiner box electrically connected to said plurality of power storage devices;
a charge controller electrically connected to said plurality of power storage devices;
an inverter electrically connected to said plurality of power storage devices; and
a plurality of volt plug receptacles connected to said plurality of power storage devices.

3. The portable solar power generation system, as recited in claim 2, wherein said tracker assembly comprises:
a skid built to ISO container dimensions having a pair of center posts on each end of said skid;
at least one brace mounted on said skid;
a tracker motor mounted on at least one brace;
a shaft extending distally from said tracker motor;
a gear attached to said shaft; and
a chain having a first end and a second end, said first end of said chain connected to a first end of one support of said plurality of supports and said second end of said chain connected to a second end of said one support of said plurality of supports, said chain connected to said gear.

4. The portable solar power generation system, as recited in claim 3, wherein said skid is further comprised of at least two female twist-lock connectors removably connected to said solar assembly.

5. The portable solar power generation system, as recited in claim 4, further comprised of a plurality of twist lock locking pins removably attached to said rail tubing and mateably removably connected to said at least two female twist-lock connectors.

6. The portable solar power generation system, as recited in claim 5, wherein said plurality of power storage devices are rechargeable lithium batteries.

7. The portable solar power generation system, as recited in claim 1, wherein said plurality of power storage devices are internal and within said cylindrical member, said plurality of storage devices interconnected in either series or parallel configurations for power storage, said configurations depending on amperage and voltage required.

8. The portable solar power generation system, as recited in claim 1, wherein said plurality of power storage devices are external to said cylindrical member.

9. A portable solar power generation system comprising:
a skid built to ISO container dimensions having a post extending distally therefrom on each corner of said skid;
a first rail tubing mounted to two of said posts;
a first array of solar panels mounted to said first rail tubing;
a second rail tubing mounted to two of said posts, said second rail tubing parallel to said first rail tubing;
a second array of solar panels mounted to said second rail tubing, said second array of solar panels parallel to said first array of solar panels; and
a plurality of power storage devices electrically connected to said first array of solar panels and said second array of solar panels.
